(19) United States
(12) Patent Application Publication
(10) Pub. No.: US 2011/0238566 A1
(43) Pub. Date: Sep. 29, 2011

(54) SYSTEM AND METHODS FOR DETERMINING AND REPORTING RISK ASSOCIATED WITH FINANCIAL INSTRUMENTS

(75) Inventor: Edward A. Santos, Maitland, FL (US)

(73) Assignee: DIGITAL RISK, LLC, Maitland, FL (US)

(21) Appl. No.: 13/113,804

(22) Filed: May 23, 2011

Related U.S. Application Data
(63) Continuation-in-part of application No. 13/028,735, filed on Feb. 16, 2011.
(60) Provisional application No. 61/304,910, filed on Feb. 16, 2010.

(51) Int. Cl. G06Q 40/00

(52) U.S. Cl. 705/38

(57) ABSTRACT

A system and methods for detecting and reporting risk associated with financial instruments, based on financial instrument data submitted by clients such as banks and financial institutions and on additional data obtained from various third party information sources. A financial risk and (associated) fraud detection system processes the financial instrument data along with data obtained from various third party information sources in order to determine a risk assessment. The risk assessment comprises a risk score and level of risk associated with the financial instrument. Further, a type of fraud associated with the financial instrument is also reported for financial instruments that are deemed to be fraudulent. Comprehensive reports are generated and reviewed by clients in order to assist in approval or rejection of individual loans or in management of multiple loans in existing portfolios.

### CROSS REFERENCE TO RELATED APPLICATIONS

This application is a continuation-in-part application, and claims the benefit of and priority under 35 U.S.C. §120 to U.S. patent application Ser. No. 13/028,735 filed Feb. 16, 2011, and entitled “System and Methods for Mortgage Fraud Detection”, which in turn claims the benefit of and priority under 35 U.S.C. §119(e) to U.S. Provisional Patent Application No. 61/304,910 filed Feb. 16, 2010, and entitled “System and Methods for Mortgage Fraud Detection.” All of the above-referenced applications are hereby incorporated by reference as if set forth herein in their entireties.

### TECHNICAL FIELD

The present invention relates generally to detecting financial instrument risk, and more particularly relates to methods and systems for detecting mortgage fraud and providing risk management tools for use in connection with new mortgage loan applications and loan portfolio management.

### BACKGROUND

The financial crisis and recession of 2008-2009 was triggered at least in part by the prevalence of complex financial instruments that in essence were collections or portfolios of mortgage loans accumulated by financial institutions. These collections of mortgage loans are called by various names, including collateralized debt obligations (CDOs), asset backed securities (ABS), and derivative securities. Such collections were formed by financial institutions, such as investment banks, and sold to other entities as investment vehicles.

The ostensible purpose of these CDOs and other derivative securities was to spread the risk of default of individual mortgages within a portfolio—default of a limited number of individual mortgages in a collection should not, in theory, significantly affect the overall value of the portfolio. However, the real effect was to spread uncertainty about the value of the underlying assets rather than reduce risk through diversification. As things turned out, the U.S. economy in particular had a housing bubble due to the ease of obtaining credit. Many borrowers who were not truly credit-worthy were able to obtain loans and were incapable of servicing their loans when the economy slowed. Credit rating agencies failed to adequately account for the possibility of a nationwide collapse of housing values when rating mortgage-backed securities, and lenders (and loan officers) were often lax in their standards of underwriting.

Although there are many explanations for the collapse of the financial markets, it has become clear that many borrowers exaggerated various facts to lenders and credit agencies, and in many cases engaged in outright fraud, in order to borrow money. Borrowers are supposed to be qualified by lending officers and mortgage underwriters, and prospective mortgage loans are supposed to be rated by trustworthy rating agencies. Due to factors such as improper and lax rating of mortgage instruments, and often outright fraud by borrowers, a high number of “bad loans” were found to form the basis of many collateralized securities. The result was a high prevalence of high risk, likely-to-default mortgages contained within many collateralized mortgage security portfolios.

When the financial markets recognized that many of the mortgages underlying collateralized securities were uncollectible bad loans that often resulted in foreclosures, a general financial collapse occurred throughout the U.S. and world economy. The results of this financial collapse have been felt in many sectors of the U.S. economy and across the world.

The typical process of assessing the risk associated with a mortgage loan involves a loan originator, working at the lending institution or bank, attempting to first investigate creditworthiness of the person(s) applying for the loan from a known credit rating agency such as Experian Information Solutions, Inc., Equifax, Inc., TransUnion, LLC, etc. A credit rating agency is a company that assigns numerical ratings for issuers having financial debt obligations from lending financial institutions. Higher values of credit rating are associated with greater confidence in the abilities of a debtor to pay back their debt obligations, and consequently greater likelihood of being qualified for a mortgage loan. A loan originator also consolidates information about the applicant's income, applicant's liabilities, existing mortgages (if any), purpose of mortgage loan, and other such information.

Furthermore, a lender might seek out information about the applicant's mortgage history—inquiring whether the applicant has some kind of pattern of being involved in multiple mortgages, or has been involved in other properties in a given neighborhood or geographical area. An applicant's complete financial background check is also performed in most cases.

In addition to applicant-specific information, a loan originator uses the services of an appraiser to estimate the value of the property being used to secure the loan. An appraiser is a person knowledgeable with real estate pricing, who provides to a loan originator the market value of the real property by taking into account factors like the type of the property in question, the physical condition of the property including materials used in construction, the aesthetic appeal of the property, the area where this property is located and the like. The use of appraisals still continues in estimating the value of real estate properties.

In recent years, lenders who wish to rely less on the appraisal have been using “automated valuation models” (AVMs). AVMs are methodologies of estimating the market value of a property utilizing some sort of mathematical modeling combined with other data such as previous appraisals, historical movements of property values in a geographical area, and property-specific data such as number of bedrooms, bathrooms, condition of property etc. Advanced AVMs can include various other methodologies such as price indexing, adjusted tax assessed value models, etc. or a hybrid model involving a combination of several methodologies. A loan originator may also inquire whether the property has undergone any previous loans or refinancings, certain kind(s) of sales, or any such attempts that might result in artificially high estimates or unusual patterns in the value of the property.

To summarize, existing methods that lenders rely on, for assessing the risk of a mortgage loan (and thereby detecting fraud) are typically determined by the financial background and creditworthiness of the applicant, history of the property in question, appraisal value of the property, and AVM methodologies used on mortgage loan information. However, these determining factors may be subject to different types of fraud. For example, an applicant might misrepresent facts in a mortgage loan application, an appraiser could be incompetent, gullible or corrupt (working in concert with wrongful interests of the applicant or property owner or other persons), or even, a loan originator could be complicit or careless. Consequently, existing methods that lending institutions or lenders rely on, can have the effect of forecasting erroneous values of the property in question.

Furthermore, commercial AVMs lack adequate data for performing a risk assessment for different types of fraud. Even if an AVM has data, it is not conventionally structured to provide a quantitative assessment of risk associated with different types of fraud. This renders the decisions made by commercial AVMs unreliable because a wrongful applicant can commit fraud that can pass undetected by a bank or financial institution as there is no way to quantify the risk. Nevertheless, lenders are also under pressure to avoid being perceived as engaging in unfair discrimination against undeserved classes of applicants (based on their ethnic background, race, social status, etc.). In many situations they may hesitate to disapprove a mortgage loan application or perhaps demand additional information from the applicant since they fear legal action of being sued or perhaps penalized by governmental entities.

Therefore, there is a need for a more objective system to evaluate and understand the reasons for “bad” mortgages with the help of a comprehensive, consolidated, and easy to use methodology that relies on sufficiently detailed data (and analysis) in connection with a mortgage loan. This will allow lenders, credit rating agencies, financial institutions, investments banks, and others involved in the lending industry for purposes of writing new mortgage loans in the future, as well as for better managing existing loan portfolios by identifying problem loans within loan portfolios.

### BRIEF SUMMARY

Briefly described, and according to one embodiment, aspects of the present disclosure generally relate to systems and methods to assess the quality of information underlying problem financial instruments involving information obtained from borrowers, lenders, and other sources of information. In particular, this application discloses various aspects of a computer-implemented information collection system and associated methods for determining and detecting risk associated with a financial instrument, and further providing such information to clients (banks and financial institutions).

According to one aspect, financial instruments comprise single mortgage loans or multiple mortgage loans bundled in a loan portfolio. According to another aspect, the system and associated methods can be utilized for both loan origination and mortgage loan portfolio management of existing loans by banks and lending institutions, and also by collateralized security holding organizations such as investment banks The present disclosure further provides various processes within a mortgage fraud detection system to facilitate the collection, processing, and storage of mortgage fraud and related financial data, classifying this information, and providing user interfaces for loan originators and mortgage loan portfolio managers.

According to one aspect, the mortgage fraud detection system (MFDS) includes a storage database that collects information relating to fraudulently acquired loans, complicit lending officers, foreclosed properties, borrower's misrepresentations of facts, and other relevant factors related to problematic (bad) mortgage loan transactions, as obtained from various sources such as financial institutions, bankruptcy courts, bank records, real estate records, credit agencies, and various such third party information sources. The described MFDS, according to another aspect, processes the disparate data received from various banks and financial institutions as well as third party information sources into a standard “normalized” format for further processing. According to another aspect, the MFDS identifies problematic (bad) mortgage loans and the underlying reason(s) that cause such loans to be problematic, based on an underwriting process. Further, an MFDS as described herein uses information from collected historical mortgage loans to create risk assessment models. Such risk assessment models are executed on financial instruments (for example, mortgage loans or portfolio of loans), provided by customers (client banks and financial institutions that wish to analyze financial instruments) to arrive at a risk score, a level of risk, and an associated type of fraud associated with the mortgage loan or portfolio. Further, according to another aspect, the MFDS provides an easy-to-use graphical interface for clients such as financial institutions to conduct new mortgage origination and existing loan portfolio management, including the ability to receive and utilize risk tolerance input data from loan originators or portfolio managers working for a financial institution.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

Although the disclosed embodiment has been described in connection with mortgage fraud detection for illustrative purposes only, and is in no way intended to limit the scope of this disclosure to assess the potential risk associated with other types of financial instruments or, a collection of various subsidiary instruments, each of which has certain risks potentially associated with it.

### BRIEF DESCRIPTION OF THE DRAWING FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is an overview of an exemplary mortgage fraud detection system (MFDS) and its associated environment, constructed in accordance with certain aspects of the present disclosure.

FIG. 2 illustrates the software architecture of the mortgage fraud detection system comprising mortgage loan data (and additional information, e.g. business rules that govern policies on processing a mortgage loan) received from banks and financial institutions, software modules, and databases that are acquired and maintained in connection with operation of the system.

FIG. 3 is a flowchart comprising steps (each step further illustrated with detailed flowcharts that follow later) illustrating an embodiment of overall MFDS process in assessing risk associated with a mortgage loan.

FIG. 4 is a flowchart illustrating computer-implemented steps performed by an embodiment of the MFDS in normalization of heterogeneous mortgage loan data (received from a plurality of banks and financial institutions) into a standard consolidated format before storage in MFDS database.

FIG. 5 is a flowchart illustrating steps performed by an analyst (using an exemplary interface discussed in FIG. 16) involving interaction with MFDS and inspection of normalization performed by MFDS (as discussed previously in FIG. 4).

FIG. 6 is a flowchart illustrating computer-implemented steps involved in performing an inquiry to third party information sources, and further processing response received from such sources.

FIG. 7 is a flowchart illustrating computer-implemented steps involved in underwriting a mortgage loan for detecting discrepancies in mortgage loan data and further providing displays/prompts for a human underwriter to interact (using an exemplary interface shown in FIG. 17) and inspect underwriting process performed by system.

FIG. 8 is a flowchart illustrating human-implemented (expert underwriter) steps for inspecting an underwritten mortgage loan, using an exemplary interface in FIG. 17.

FIG. 9 is a flowchart illustrating steps in forecasting risk(s) associated with a mortgage loan by executing proprietary mortgage risk assessment models (named herein as CORAL and PLATES) on normalized and underwritten mortgage loan data.

FIG. 10 is a flowchart illustrating steps involved in the construction of proprietary risk assessment models such as CORAL and PLATES for assessing risks associated with new mortgage applications as well as management of existing loan portfolios.

FIG. 11 is a flowchart illustrating computer-implemented steps performed by an embodiment of the MFDS involving appropriate data displays and prompts for an individual working at a bank or financial institution and authorized to interact and export result of the risk assessment performed by MFDS.

FIG. 12 is a flowchart illustrating steps taken an individual working at a bank or financial institution and authorized to interact and export results of the risk assessment performed by MFDS, using an exemplary interface as shown in FIG. 18.

FIG. 13 is an exemplary database schema showing the principal tables and data columns in MFDS Database for storing information pertaining to mortgage loan data.

FIG. 14 is an exemplary database schema showing tables and constituent fields in MFDS Database for storing information pertaining to authorized users (individuals authorized to access the results of risk assessment performed by MFDS) working at clients (banks or financial institutions).

FIG. 15 is an exemplary database schema showing tables storing representative variables used in connection with mortgage risk assessment models (CORAL and PLATES).

FIG. 16 is an exemplary screenshot of a graphical user interface (GUI) viewed by an internal analyst who uses this interface according to the steps discussed in FIG. 5, in order to inspect normalization performed by system.

FIG. 17 is an exemplary screenshot of a graphical user interface (GUI) viewed by an internal analyst involved in analysis and underwriting and/or otherwise approving a mortgage loan application (according to the steps shown in FIG. 8).

FIG. 18 is an exemplary screenshot of a graphical user interface (GUI) viewed by an individual working at a bank or financial institution who is authorized to interact and export result of the risk assessment performed by MFDS, according to the steps discussed in FIG. 12.

### DETAILED DESCRIPTION OF THE DISCLOSED EMBODIMENTS

To provide an overall understanding of the present disclosure and its various aspects, certain illustrative embodiments will now be described, including a Web-deployed, client/server (and/or cloud computing based) architecture for detecting mortgage fraud, and/or determining and reporting risks associated with a financial instrument. The systems and methods described herein have particular applicability in a financial context, such as where a loan origination officer at a financial institution requires assistance in determining whether to grant a loan to a prospective borrower, or where a mortgage loan portfolio manager at a financial institution requires information to assist in identifying potential problem loans in the portfolio and manage the holdings in the portfolio. However, it will be understood that the methods and systems described herein can be suitably adapted to any environment where data from the various sources described below is provided for inclusion in a database of information relating to mortgage loans or other financial instruments. These and other applications of the systems described herein are intended to fall within the scope of the disclosure.

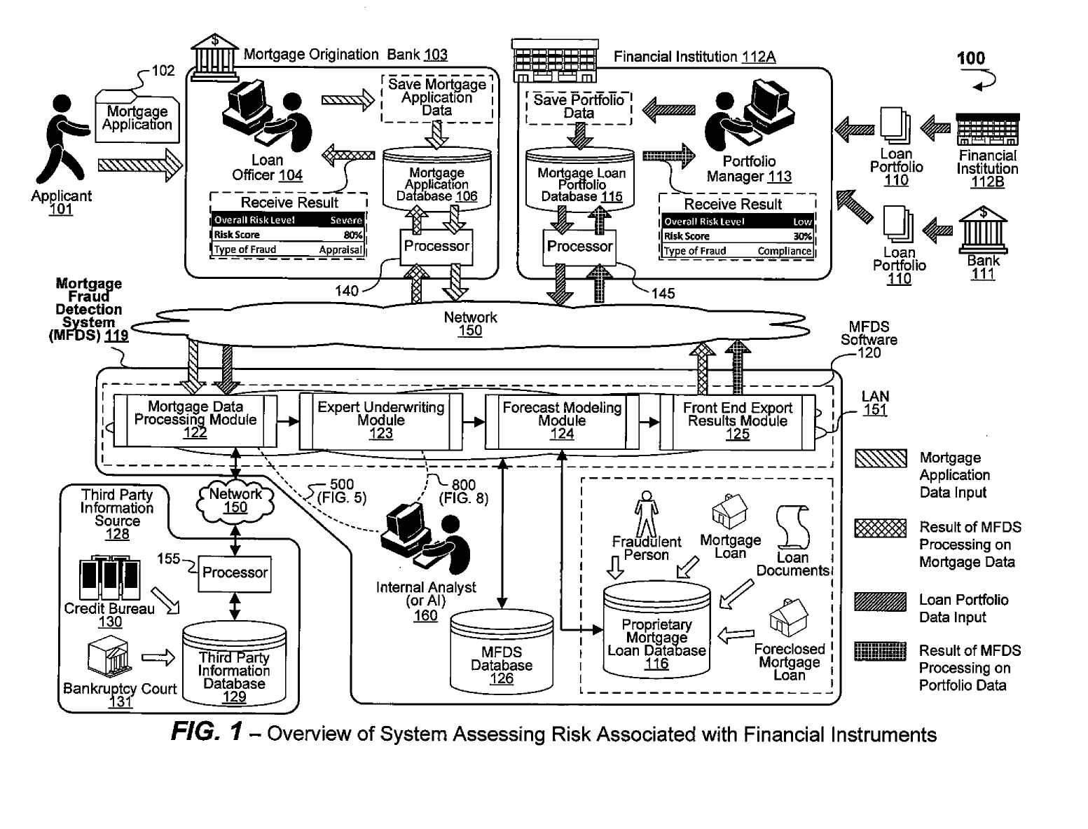

Referring now to the drawings, in which like numerals indicate like elements, steps, processes and data throughout the several drawing figures, FIG. 1 illustrates an overview of a mortgage fraud detection system (MFDS) 119 and its associated environment. Also shown is an exemplary embodiment of a mortgage loan application process 100 with an applicant 101 applying for a new mortgage loan by completing a mortgage application 102 at a fictitious mortgage origination bank 103. Loan Officer 104 working at mortgage origination bank 103 receives mortgage application 102 from applicant 101. According to one aspect of the present disclosure, mortgage applications are saved by loan officers in a database at the mortgage origination bank. Such a database is referred to as Mortgage Application Database 106, for illustrative purposes. A collection of mortgage loans bundled into a loan portfolio 110 is received from a bank 111 or a financial institution 112B by a portfolio manager 113 working at a financial institution 112A. According to one aspect of the present disclosure, portfolio managers receive loan portfolios and saves them in a database at the bank or financial institution. Such an exemplary database is called as Mortgage Loan Portfolio Database 115, as shown in FIG. 1. As can be understood by a person skilled in the art, single mortgage applications 102 as well as loan portfolios 110 can comprise a combination of electronic documents (that can be stored in a database) and additional paper documents that have been hand-typed by individuals, e.g., applicants or other individuals working at a bank or financial institution.

Moreover, those skilled in the art will understand and appreciate that the system and methods discussed herein can be used to analyze any type of financial instruments and is not limited to single mortgage loans or loan portfolios. Data from such loan documents are stored and processed with the help of additional data and computational models as described in the present disclosure to generate meaningful information (outcome of performing risk-assessment of a fraud mortgage loan) that will assist in deciding whether or not to grant a loan to an applicant 101 or in identifying potential problem loans in a loan portfolio 110. As shown in FIG. 1, outcomes of processing single mortgage applications and loan portfolios include (but not limited to) an overall fraud level, a risk score, and a type of fraud. Overall fraud levels associated with a mortgage loan signify the levels of risk tolerance. Risk scores are numerical scores that typically indicate the probability of fraud associated a financial instrument. Risk scores are obtained by executing risk assessment models on financial instruments. Those skilled in the art will further appreciate that a financial instrument can be subjected to various types of fraud. Typical fraud types include appraisal, compliance, liability, misrepresentation, occupancy, and other such fraud. Pre-categorized fraud types and overall fraud levels risk are stored in a database table and will be described later. Further, as will be seen, various processes involved in arriving at outcomes of MFDS processing will also be discussed in greater detail.

Still referring to FIG. 1, a processor 140 at mortgage origination bank 103 or a processor 145 at financial institution 112A communicates with a Mortgage Fraud Detection System (MFDS) 119 that is a network-accessible server, via a network 150. As mentioned previously, this communication, which generally involves transmitting loan documents first and subsequently receiving risk assessment outcomes on those loans at a later time, can occur via one or the other services: a Web-deployed service with client/service architecture, a corporate LAN, or through a cloud-based system. In the present system, it is understood that mortgage origination bank 103 or financial institution 112A and any entities or individuals involved with them are generally referred to as clients herein, in a client/server or cloud computing type architecture. The connections between such clients and servers are provided by a network 150. As will be further understood and appreciated, any number of clients and servers could participate in and comprise such a system.

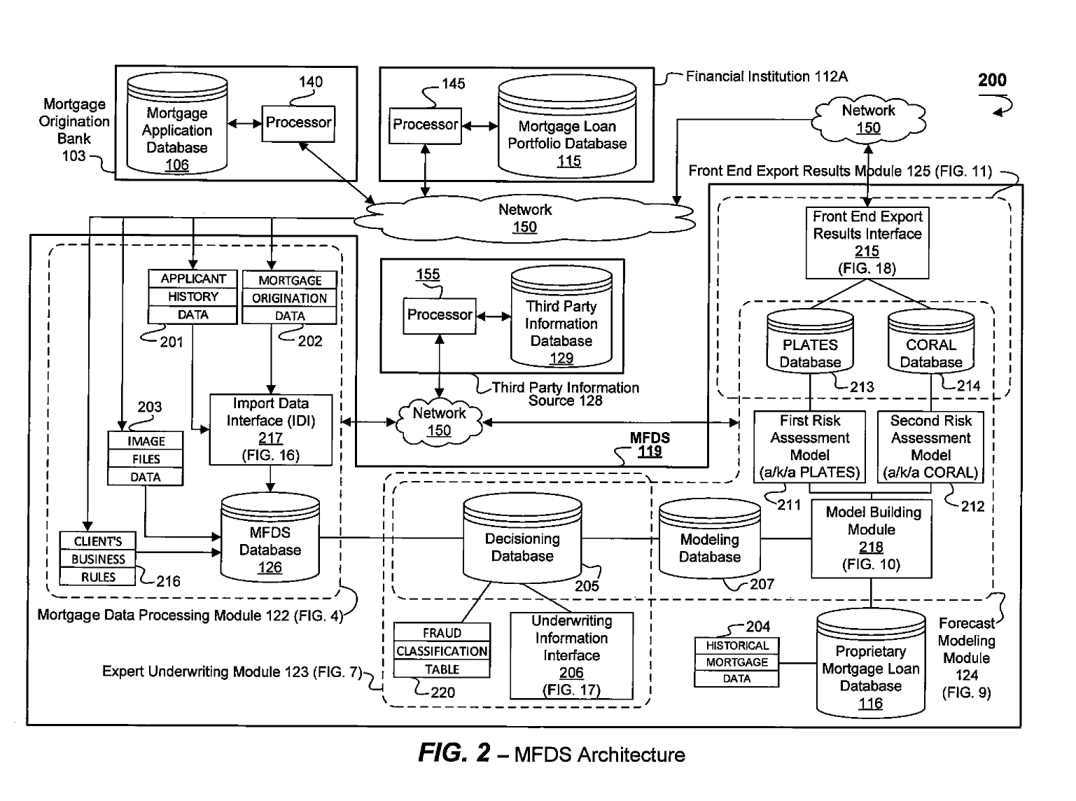

Architectural details of MFDS 119 comprising a plurality of software modules, interfaces and databases are shown in FIG. 2. As will be appreciated by those skilled in the art, software modules comprise computer programs or routines that are executed on a computer system so as to provide the functionality described herein. For the purposes of illustration, FIG. 1 shows MFDS 119 comprising MFDS Software 120, MFDS Database 126, and Proprietary Mortgage Loan Database 116. MFDS Software 120 further comprise a plurality of software modules—a Mortgage Data Processing Module 122, an Expert Underwriting Module 123, a Forecast Modeling Module 124, and a Front End Export Results Module 125.

As shown with the help of shaded arrows, client provided mortgage data in the form of single mortgage loan applications or multiple loans bundled in a loan portfolio are received by MFDS 119. As will be understood by a person skilled in the art, steps involved in processing a loan portfolio are similar to the steps involved in processing a single mortgage application. This is because multiple loans bundled in a loan portfolio are individually processed as single mortgage applications by various software modules of MFDS 119. Client provided mortgage data (single mortgage loans or a loan portfolio containing several loans) undergoes a series of successive transformations (computer implemented processing) to result in an outcome comprising an overall risk level, a risk score and a type of fraud that is used to assess risk associated with a mortgage loan. According to one aspect of the present disclosure, outcomes of processing a financial instrument is available for display to clients via a graphical user interface, either instantaneously, or after a time delay. As will be explained herein in greater detail, a plurality of software modules process client provided mortgage data (single mortgage loans or a loan portfolio containing several loans) from an initial raw form to a final outcome.

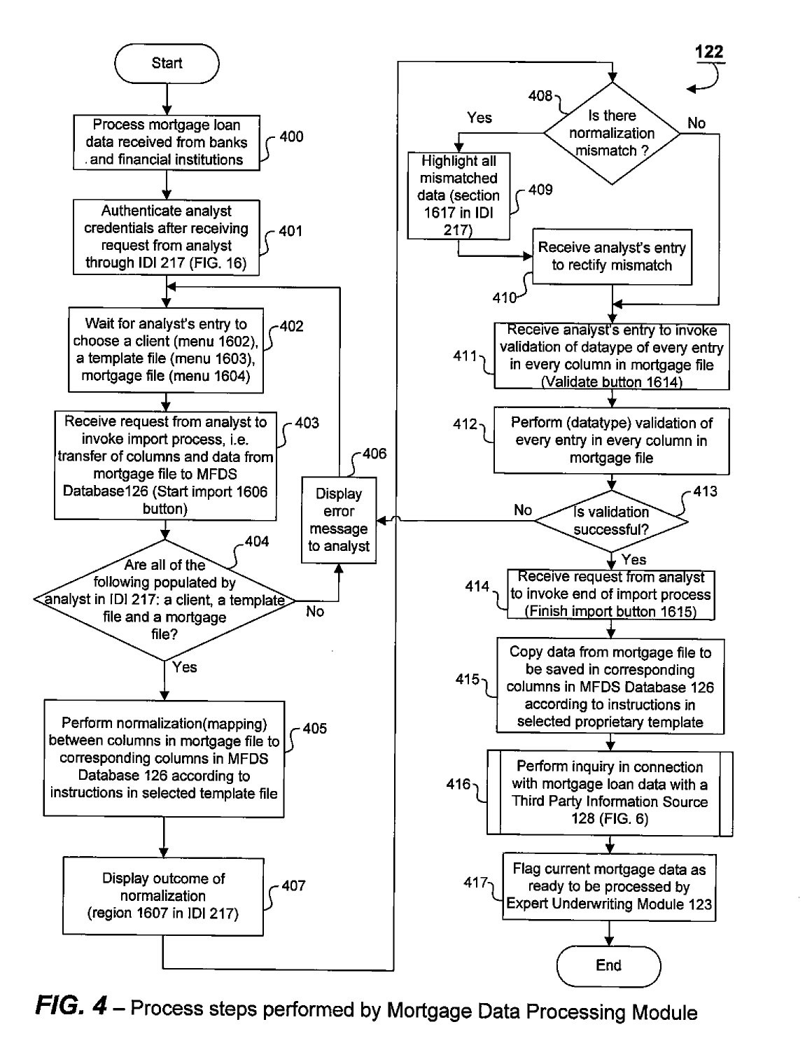

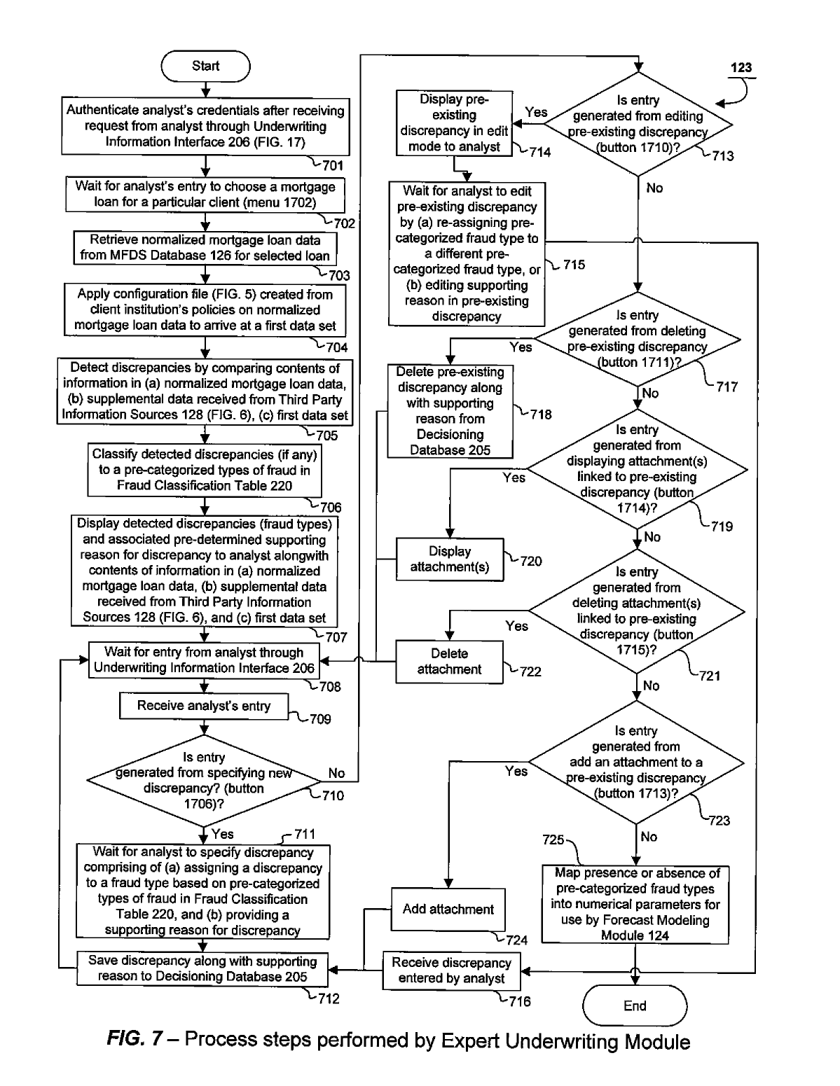

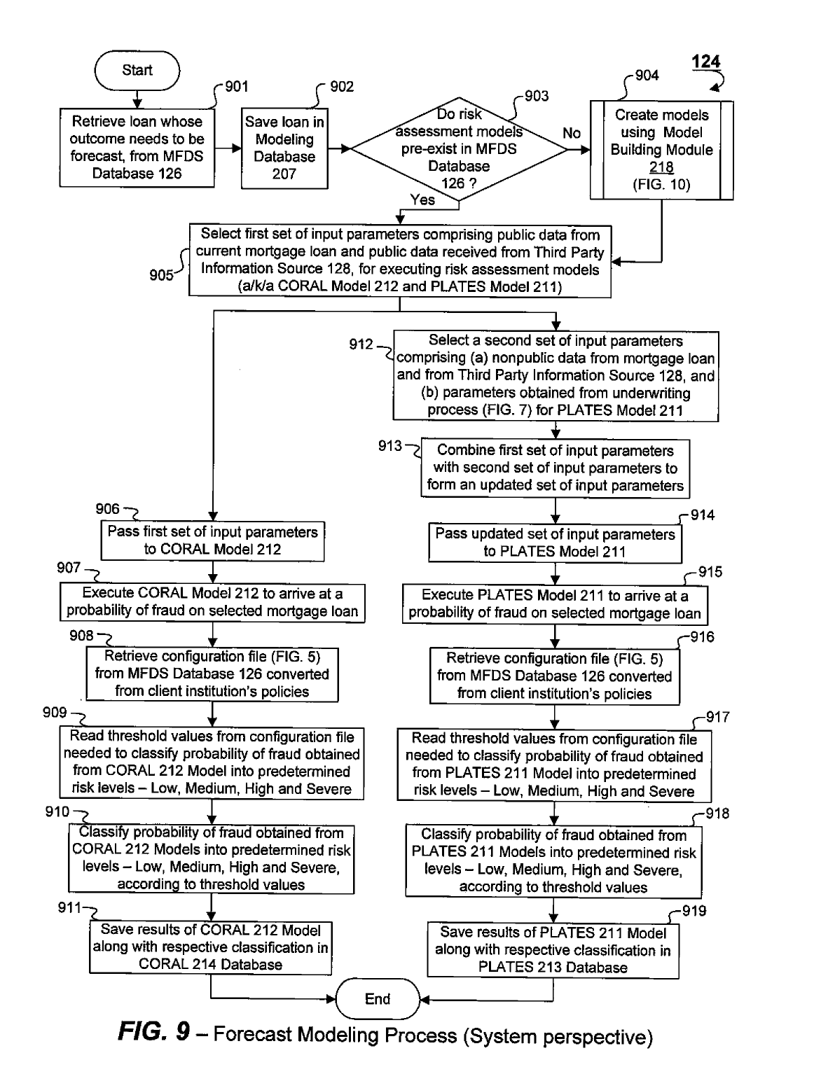

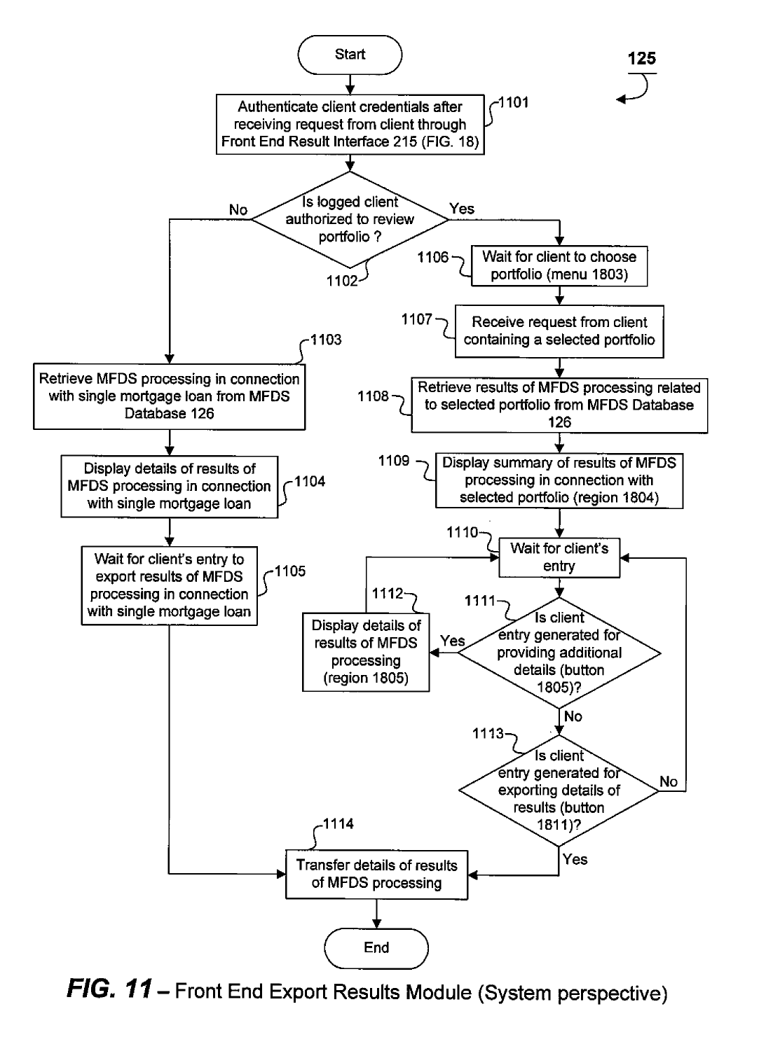

Details of operation of software modules are described with respective flowcharts in accompanying figures—Mortgage Data Processing Module 122 in FIG. 4, Expert Underwriting Module 123 in FIG. 7, Forecast Modeling Module 124 in FIG. 9, and Front End Export Results Module 125 in FIG. 11. Software modules in MFDS Software 120 are interconnected in a Local Area Network (LAN) 151 through one or more gateways (not shown), that provides security to the LAN 151 and also ensures operating compatibility between the LAN and the network 150. A high-level description of software modules that comprise MFDS Software 120, MFDS Database 126 and Proprietary Mortgage Loan Database 116 are described in what follows below.

According to one aspect, electronic copies of financial instruments (e.g., mortgage loans, loan portfolios) are communicated via network 150 and received by MFDS 119 at a FTP server. In several situations, in addition to electronic loan documents, a mortgage loan also consists of hand-written copies of loan documents. Usually such hand-written documents contain the same information as the electronic documents, but in some cases might include additional information as well. These documents are filled by applicants 101 or individuals working at mortgage origination banks 103 or financial institutions 112. Such hand-written documents are also transmitted to MFDS 119, and utilized in combination with electronic documents in assessing risks associated with a loan. As will be understood by one of ordinary skill in the art, loan documents may be transmitted to the MFDS continually, for example, in periodic or intermittent basis, or batch processed and transmitted once daily, or transmitted via some other similar recurring transmission method. Those skilled in the art will understand and appreciate that loan documents can also be processed by embodiments of the MFDS in real-time.

At predetermined time intervals (e.g., daily, weekly, monthly) or continuously or on request, data comprising electronic and hand-written copies of loan documents pertaining to a specific mortgage loan are received at a Mortgage Data Processing Module 122 (a constituent software module of MFDS Software 120) from banks or financial institutions. Hand-written documents (if any) are first scanned and then stored along with electronic documents of the same mortgage loan in MFDS Database 126. As can be understood by a person skilled in the art, loan data received by MFDS 119 comes from heterogeneous sources—a variety of banks and financial institutions each following their own file format (Microsoft® Word® documents, Microsoft® Excel® spread sheets, Adobe® PDF® documents, etc.) or formatted text files. Further, each bank or financial institution has its own policy of acquiring, storing, using, and redistributing loan data. Those skilled in the art will understand and appreciate that there is a need to “normalize” the loan data received various disparate (heterogeneous) loan sources and different file formats into a common format that would allow in storage, accumulation, and utilization. As a result, the received loan data is subjected to a normalization process of by MFDS 119.

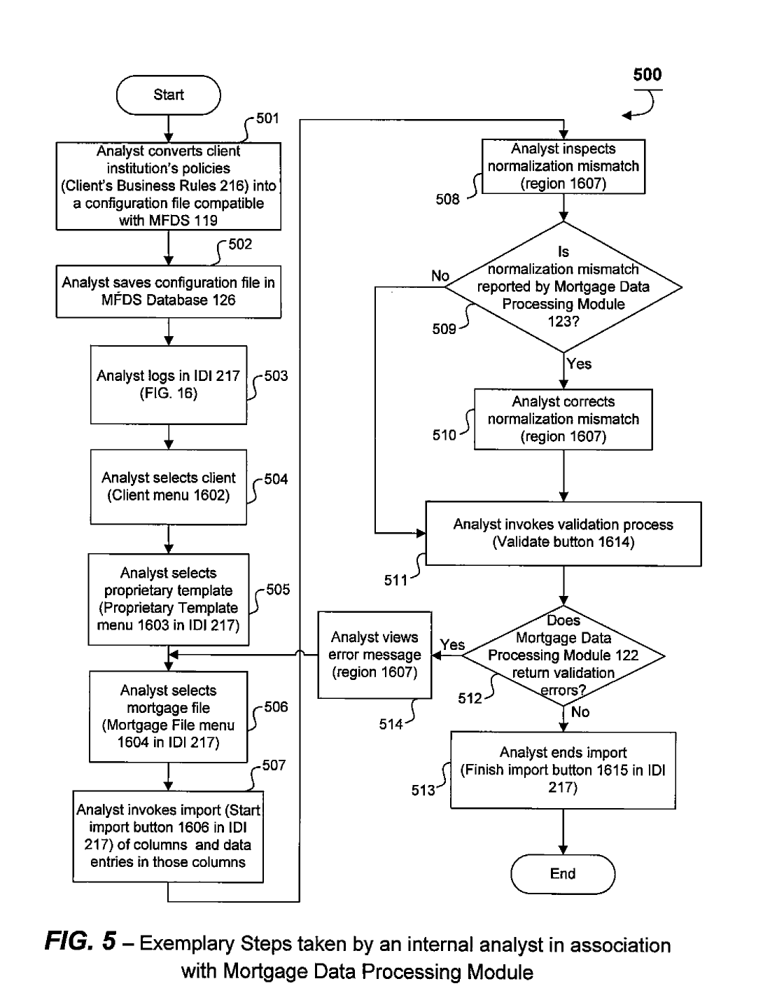

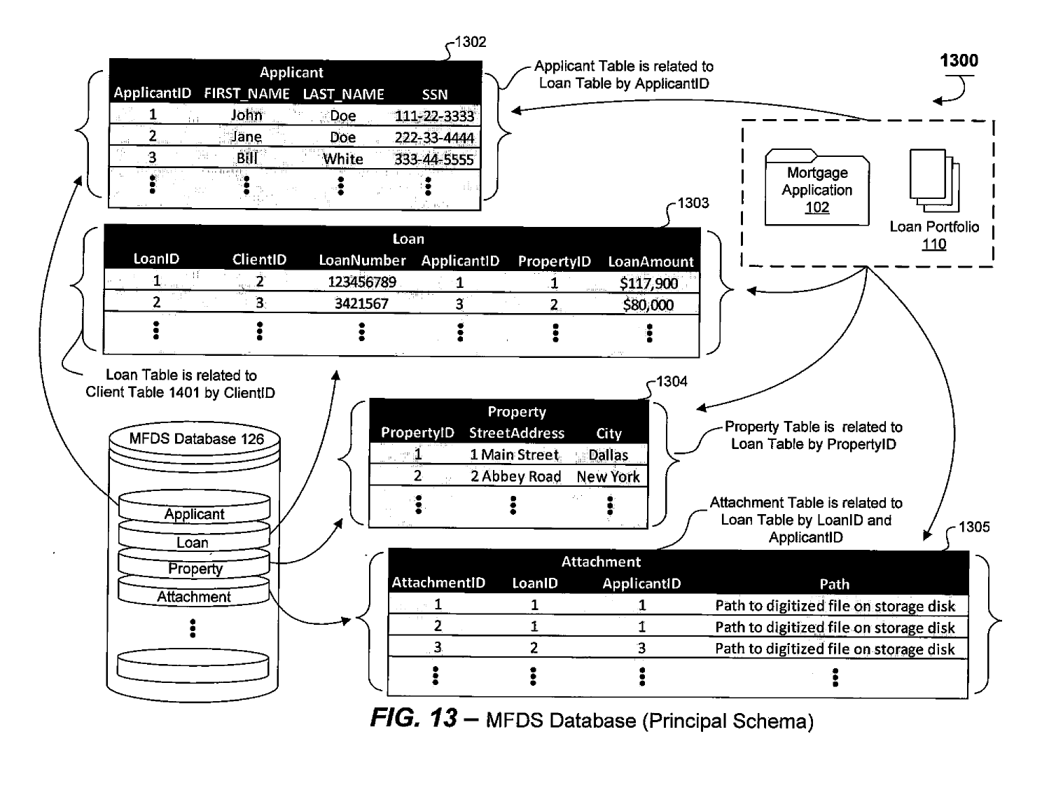

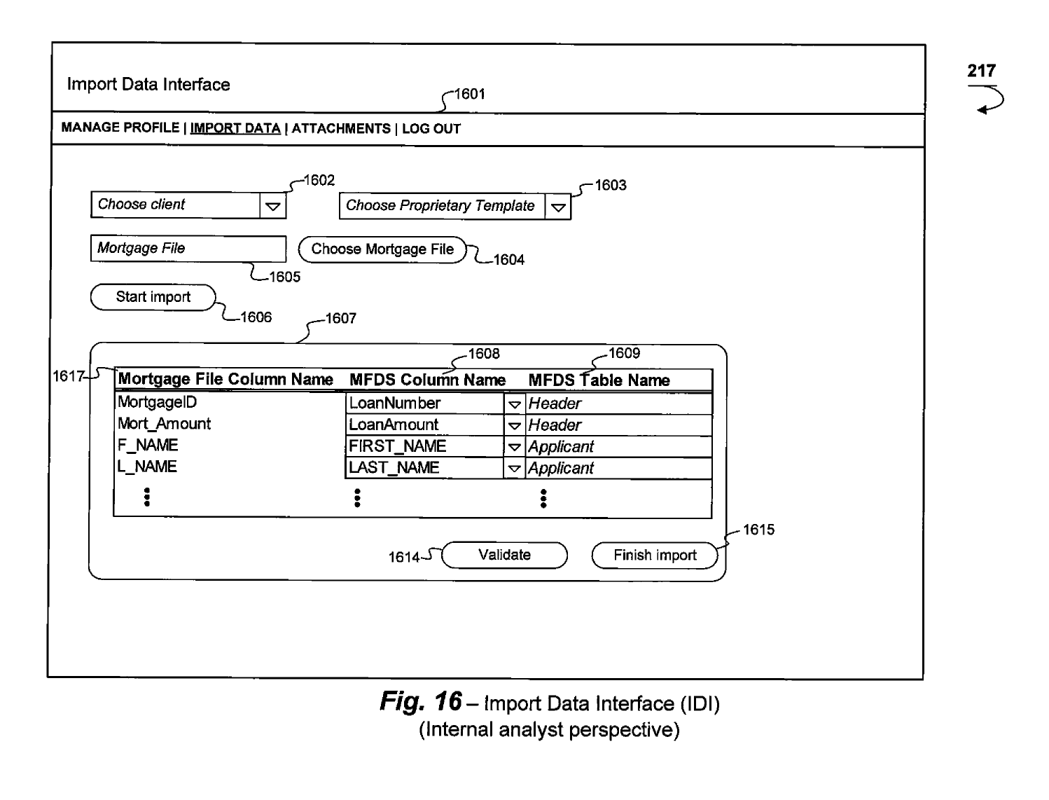

According to one embodiment of the present disclosure, a normalization process is performed by a Mortgage Data Processing Module 122. Details of the normalization process performed by Mortgage Data Processing Module 122 are described in detail in FIG. 4. Normalization includes (but is not limited to) the steps of converting received loan data into a common format, populating tables in MFDS database 126 correctly with entries going into the proper column, etc. Normalization performed on mortgage loan data by Mortgage Data Processing Module 122 is further inspected by an internal analyst 160 (using an Import Data Interface 217 as shown in FIG. 16, and according to process steps 500 described in FIG. 5) who interacts with MFDS 119 according to the steps described in FIG. 5 and ensures that the data has been correctly entered into the system, for example, data is entered in the appropriate data tables. Those skilled in the art will further understand and appreciate that advances in machine intelligence will enable computers equipped with Artificial Intelligence (AI) to perform tasks currently performed by human analysts, in the future. Exemplary data tables including data structures (for example, columns and fields) illustrating representative data that is received and stored in MFDS Database 126 is shown in FIG. 13.

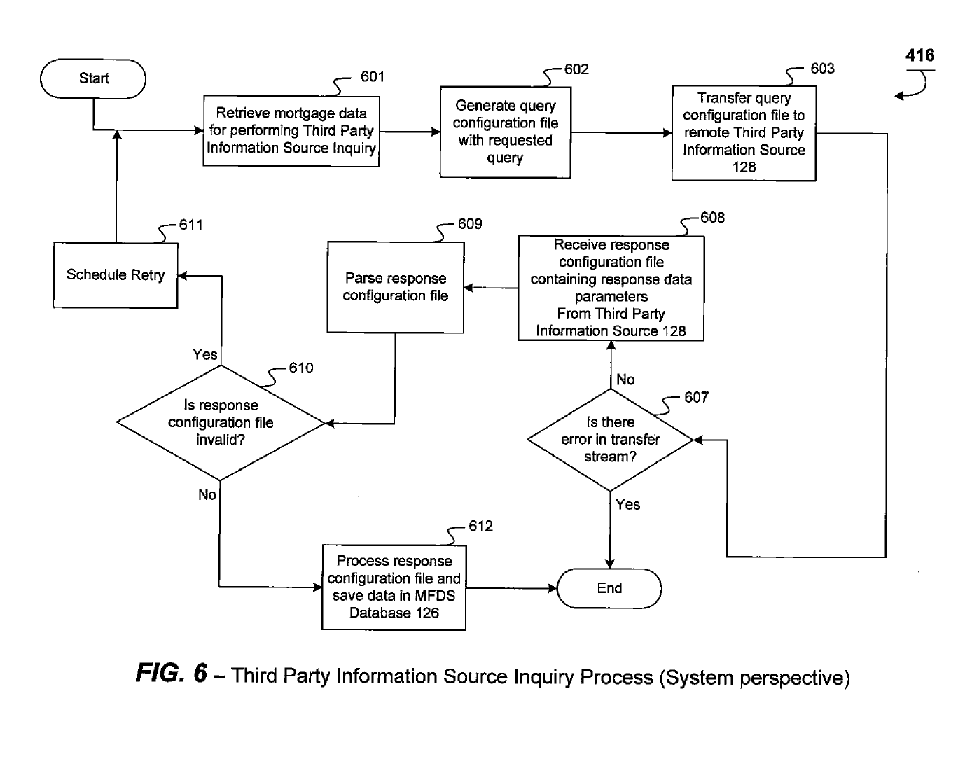

The normalization process also causes the data to be amenable for query and further processing by one or multiple Third Party Information Sources 128 that provide(s) additional related and often unrelated data from third party sources, e.g. data pertaining to particular borrowers, properties, credit records, court records, etc. Examples of Third Party Information Sources include compliance and regulatory entities providing automated valuation models (AVM's) like Corelogic, MAVENT, MERS (Mortgage Electronic Registration System), and also credit bureau agencies, bankruptcy courts, government agencies such as FDIC, LexisNexis, MAVENT, etc. Steps involved in MFDS 119 performing an enquiry about a mortgage loan to a Third Party Information Source 128 are described with a flowchart in FIG. 6.

As shown in FIG. 1, after the completion of normalization process by the Mortgage Data Processing Module 122 and subsequent inspection (according to a process 500 shown in FIG. 5) performed by a human internal analyst, or an artificial intelligence (AI) based computer 160, normalized data is then subsequently used by an Expert Underwriting Module 123 that performs underwriting of a mortgage loan. As explained in detail in FIG. 7, underwriting of a mortgage loan involves the task of detecting discrepancies in mortgage loan data, potentially arising out of various entities involved in the loan, such as loan officers, borrowers, applicant(s) etc. in conjunction with additional data received from Third Party Information Sources 128. Examples of discrepancies include but are not limited to misrepresentation of information provided by loan applicant to the bank or financial institution, e.g., invalid zip code, misrepresented Social Security Number, wrongful appraisal by a corrupt loan officer working in concert with an applicant etc.

According to one aspect of the present disclosure, these discrepancies are assigned a pre-categorized fraud type to indicate the type of fraud (exemplarily shown in FIG. 1) associated with a mortgage loan. For example, if an applicant's Social Security Number provided by applicant in a mortgage loan application 102 does not match applicant's Social Security Number in applicant's public records (available from a Third Party Information Source 128), then this is assigned a Social Security Number misrepresentation fraud. The pre-categorized fraud types are listed in a Fraud Classification Table 220 (shown in FIG. 2). Various discrepancies (and correspondingly various fraud types) detected in raw mortgage loan data provided by banks and financial institutions are converted to numerical parameters which are then used to assess risk associated with a mortgage loan by a Forecast Modeling Module 124 as explained with a detailed flowchart in FIG. 9.

A Forecast Modeling Module 124 utilizes underwritten mortgage loan data and data from Third Party Information Sources 128 in predicting risk of fraud associated with a loan. According to an embodiment, prediction of risk of fraud involves execution of risk forecast (risk assessment) models in order to arrive at a risk score (a number). These scores reflect the fact that certain types of mortgages or applicants will have greater risks of fraud or mis-representation than others. For example, an applicant who has filed for bankruptcies, or a property that has been involved in an unusually high appraisal (relative to other properties in its neighborhood) value are likely to be associated with greater risk of fraud.

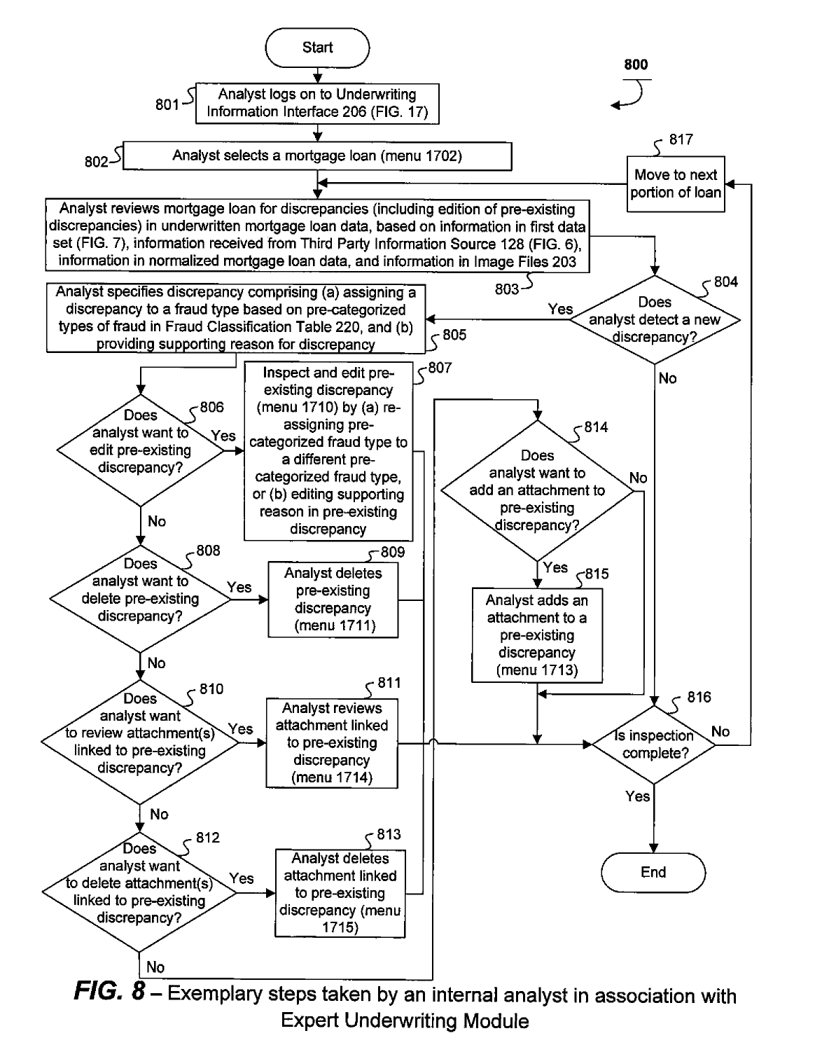

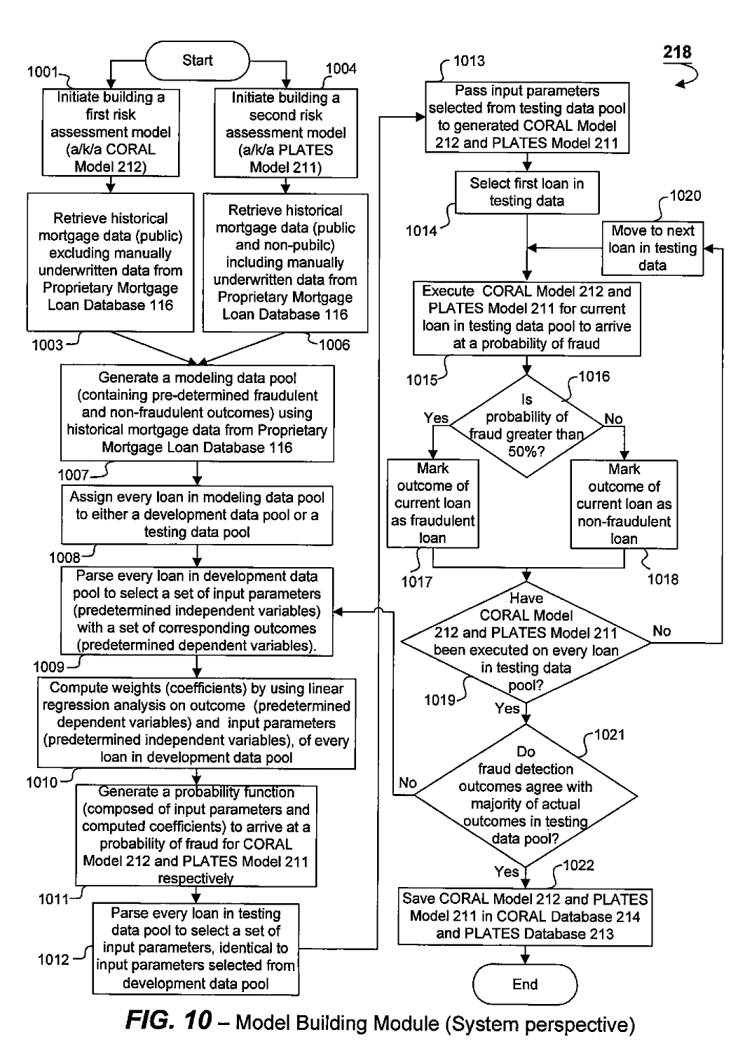

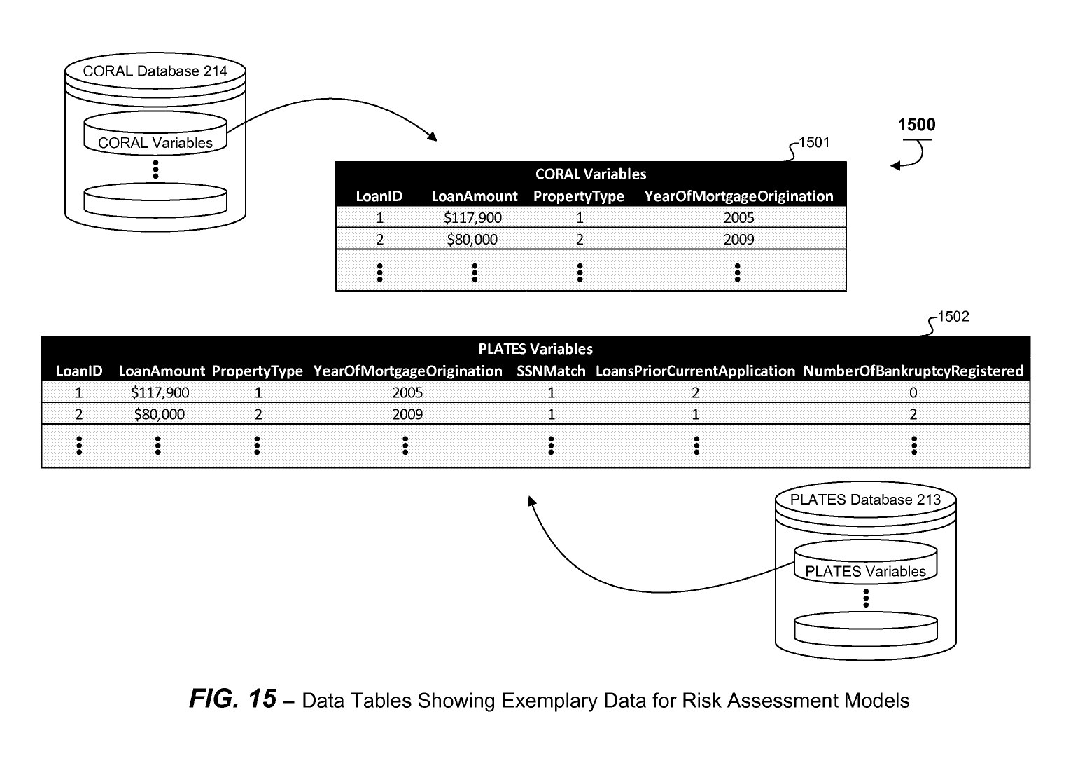

Risk assessment models are statistical models that are executed on a mortgage loan after the loans are subjected to a normalization process (explained in FIG. 4 in greater detail) and an underwriting process (explained in FIGS. 7, 8 in greater detail). Risk assessment models or risk forecast models are used to predict a risk score (a number) associated with a financial instrument. According to one embodiment of the present disclosure, one of such risk forecast models is named herein as a CORAL Model 212, and another model is termed a PLATES Model 211. These models are constructed by a Model Building Module 218 (not shown in FIG. 1) and shown in FIG. 10. CORAL Model 212 and PLATES Model 211 utilize several input variables involved in mortgage loan data (provided by clients and Third Party Information Sources 128) to arrive at an outcome of MFDS processing of the mortgage loan. As shown in FIG. 1, typical outcomes of processing single mortgage applications and loan portfolios include (but not limited to) an overall risk level, a risk score, and a type of fraud, associated with the mortgage loan. Examples of input variables include: mortgage loan amount; a flag indicating if mortgage is for an apartment, a house, a condominium; a flag indicating if an applicant has a history of filing bankruptcies; historical sales records of subject property; historical sales records of properties sales in the surrounding area; and the like. Exemplary data tables showing input variables for CORAL Model 212 and PLATES Model 211 are shown in FIG. 15.

Mortgage loan data related variables used in the construction of CORAL Model 212 and PLATES Model 211, are derived from historical mortgage data that is stored in a Proprietary Loan Database 116. Proprietary Mortgage Loan Database 116 comprises various kinds of mortgage data—data from previous loans including foreclosed mortgage loans, documents obtained from loans, fraudulent activity associated with pre-stored (historical) loans, as well as loans that are non-fraudulent. These loans are historically collected from mortgage origination banks, financial institutions, Third Party Information Sources 128, and aggregated by MFDS 119. According to one embodiment, some of the pre-stored mortgage loans have been processed for risk assessment by MFDS 119 previously.

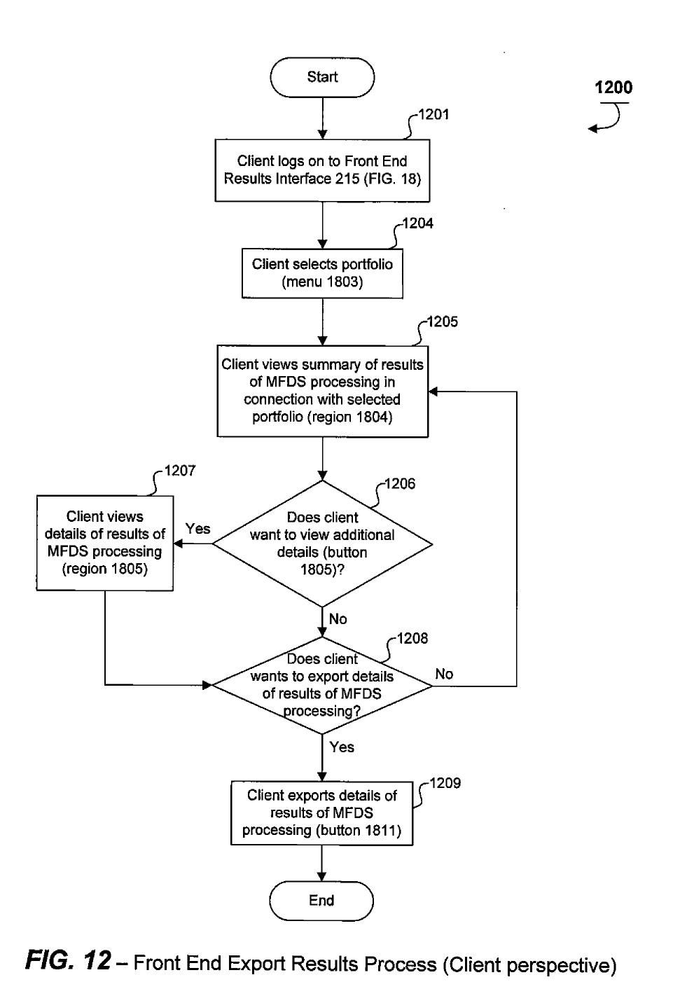

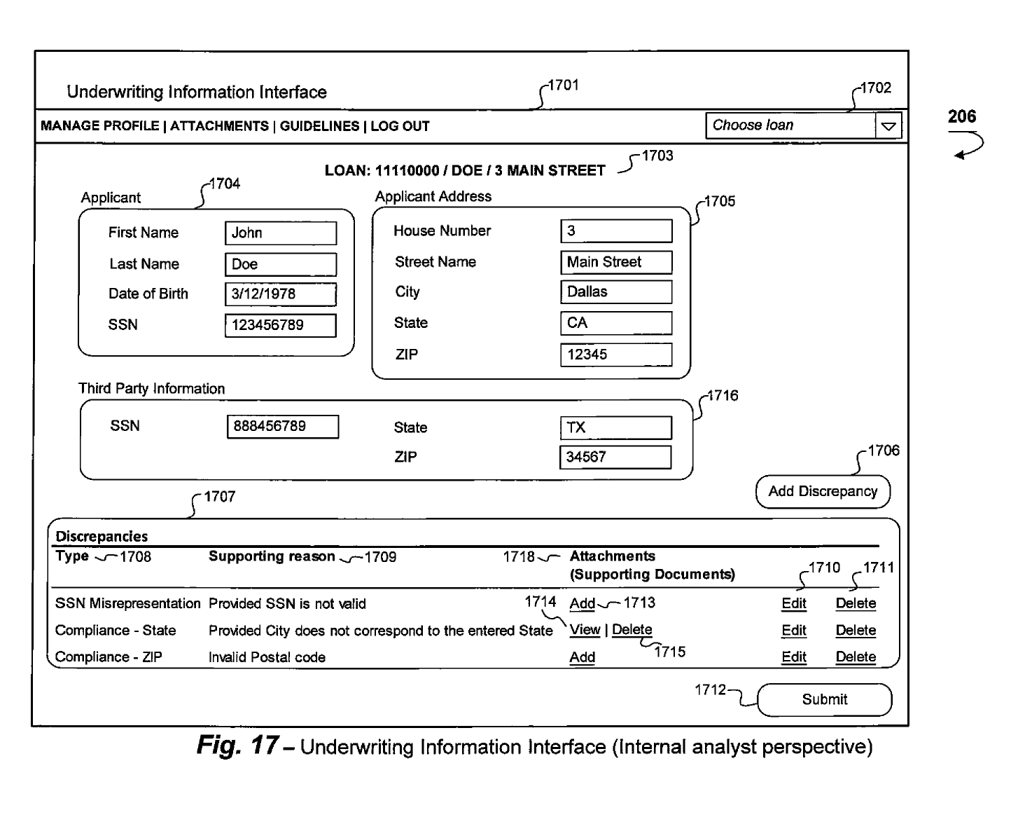

Still referring to FIG. 1, risk scores (outcome of performing risk-assessment on mortgage loans) predicted by CORAL Model 212 and PLATES Model 211, are further classified to a predetermined risk level by Forecast Modeling Module 124. Risk levels associated with a mortgage loan are utilized by loan officers 104 working at a bank 103 to decide whether or not to grant a mortgage loan to an applicant 101, and can also be utilized by portfolio managers 113 working at financial institutions 112A for purposes of identifying problem loans within a loan portfolio 110 and take appropriate actions accordingly. According to one embodiment, loan officers 104 and portfolio managers 113 authorized to review and export risk-assessment results interact (according to the steps shown in FIG. 11) with a Front End Export Results Module 125 through a Front End Results Interface 215 (shown with an exemplary screenshot in FIG. 17). Details of steps performed by Front End Export Results Module in displaying results of risk assessment (outcome of MFDS processing) are shown in FIG. 12. Turning now to FIG. 2, an exemplary system architecture 200 comprising software modules, interfaces, databases, data tables and data received from banks and financial institutions, for one embodiment of the MFDS 119 is shown, constructed in accordance with aspects of the disclosure. As can be seen, the architecture includes MFDS 119, at least one mortgage origination bank 103 (which further includes a Mortgage Application Database 106 containing data pertaining to single loan applications and a processor 140) or a financial institution 112A (which further includes a Mortgage Loan Portfolio Database 115 containing bundled mortgage loan applications and a processor 145), and a Third Party Information Source 128 (which further comprises Third Party Database 129 and a processor 155). Further, as will be appreciated, although only one database is shown each for mortgage origination bank 103, financial institution 112A, and Third Party Information Source 128, embodiments of the present system utilize many databases to store system information as needed.

According to an aspect of the present disclosure, mortgage origination bank 103, financial institution 112A, MFDS 119, and their respective components, communicate with each other via a conventional service-oriented architecture (SOA). Generally, a service-oriented architecture is an information technology infrastructure that allows different applications to exchange data with one another. Typically, a SOA separates functions into distinct units or services, which are made accessible over a network (such as the Internet), such that users of the system can combine and reuse them as desired. As will be understood, the communication protocol between the system components shown in FIG. 2 may vary depending upon each financial institution's preferred communication technique, and various file transfer mechanisms may be used according to embodiments of the present system.

As shown in FIG. 2, MFDS 119 comprises a plurality of software modules—a Mortgage Data Processing Module 122, an Expert Underwriting Module 123, a Forecast Modeling Module 124 and a Front End Export Results Module 125. Details of operation of the software modules are described with respective flowcharts in accompanying figures—Mortgage Data Processing Module 122 in FIG. 4, Expert Underwriting Module 123 in FIG. 7, Forecast Modeling Module 124 in FIG. 9, and Front End Export Results Module 125 in FIG. 11.

Data related to loans, borrowers, amounts, locations of property, payment history, applicant's income, etc. is received from banks, various financial institutions such as lenders, along with actual mortgage loan documents in electronic form and/or scanned images thereof are received by Mortgage Data Processing Module 122 of MFDS 119 and saved in MFDS Database 126. In the embodiment described in FIG. 2, MFDS Database 126 functions as a “master database” and (a) provides information to other modules and databases as needed, and (b) receives status of processing done by other modules, and accordingly updates its records for future processing or analysis by humans or software modules as necessary. Exemplary data tables or structures illustrating representative data that is received and stored in MFDS Database 126 are shown in FIG. 13. According to one embodiment, data from banks and financial institutions and stored in MFDS Database 126 is categorized as Applicant History Data 201, Mortgage Origination Data 202, Image Files Data 203 and Client's Business Rules 216.

Applicant History Data 201 comprise information that uniquely identify the applicant—name, date of birth, residential address, social security number, information pertaining to previous mortgages—payment history, rate of interest, number of payments made on previous mortgage, etc.

Mortgage Origination Data 202 comprises data related to said mortgage loan at the time of loan origination that forms the basis of analysis of the present disclosure. This includes, for example, mortgage loan amount applied for, date of application, property in connection with said mortgage loan application, etc.

Image Files Data 203 includes scanned images (image files) of hand-filled paper documents or the actual hand-filled paper documents themselves. As can be understood by those skilled in the art, various computer programs (for example, optical character recognition (OCR) programs) are available commercially for processing scanned image files and extracting meaningful textual and numerical information in order to make such information searchable. As a result, hand-written paper documents are scanned first, then the underlying data is extracted from these image files using text/character recognition programs, and eventually the extracted data is saved in MFDS Database 126. According to one embodiment, individual hand-written loan documents are scanned into a single loan file, with individual scanned documents in the single loan file being indexed (for access and retrieval of contents in original files) by an indexing table that is saved in MFDS Database 126.

Client's Business Rules 216 (also referred to as client institutions' policies) comprise corporate policies defined by respective clients (banks and financial institutions) that generally govern how mortgage loans are to be processed. Typically, these rules provide policies of qualifying mortgage loan data that is deemed relevant by a particular client. Client's Business Rules 216 differ from one client to another. For example, a client may specify a maximum LTV (Loan-To-Value) of 80%. The LTV is a ratio of amount of mortgage loan amount applied for, to the appraised value of the property. For instance, if a borrower wants $120,000 to purchase a house worth $160,000, the LTV ratio is $120,000/$160,000 or 75% (LTV). As shown in FIG. 5, a human analyst converts Client's Business Rules 216 into a configuration file compatible to be processed by MFDS 119.

As will be explained with the help of a flowchart in FIG. 4, Mortgage Data Processing Module 122 performs normalization on received mortgage loan data along with aggregating additional data from other Third Party Information Source 128 that provide(s) additional related and often unrelated third party data, e.g. data pertaining to particular borrowers, properties, credit records, court records, etc. An internal analyst interacts with Mortgage Data Processing Module 122, (using an Import Data Interface 217 as shown in FIG. 16) according to the steps described in FIG. 5 to inspect the normalization that is performed by the system. Data that is normalized by the system and inspected by internal analyst data is saved in MFDS Database 126 to be utilized by Expert Underwriting Module 123.

Expert Underwriting Module 123 performs underwriting on mortgage loan data as described in FIG. 7 and displays appropriate data displays/prompts for a human underwriter to interact and provide data input to the system. As will be described in detail later, underwriting involves searching for discrepancies in a mortgage loan using data received from clients (banks and financial institutions) and data received from Third Party Information Sources 128, and then assigning a discrepancy to one or more pre-categorized fraud types. Typical fraud types include appraisal, compliance, liability, misrepresentation, occupancy, and other such fraud. Pre-categorized fraud types are stored in a Fraud Classification Table 220 that is stored in Decisioning Database 205.

As shown in FIG. 2, Expert Underwriting Module 123 comprises Decisioning Database 205 (connected to MFDS Database 126) and an Underwriting Information Interface 206. A human underwriter interacts (according to the steps in FIG. 8) with Expert Underwriting Module 123 using Underwriting Information Interface 206 (as shown with an exemplary screenshot in FIG. 17) to inspect underwriting performed by Expert Underwriting Module 123, and provides additional input (if necessary). Underwritten mortgage data stored in a Decisioning Database 205 is transferred to a Modeling Database 207 for use by a Forecast Modeling Module 124.

Forecast Modeling Module 124 (described in detail in FIG. 9) comprises a Model Building Module 218 (described in detail in FIG. 10) connected to Modeling Database 207, which is connected to Decisioning Database 205. Forecast Modeling Module 124 forecasts risk(s) associated with a mortgage loan by executing proprietary risk assessment models (named herein as CORAL Model 212 and PLATES Model 211) on normalized and underwritten mortgage loan data. Risk assessment models are first created by Model Building Module 218 using historical mortgage data available in Proprietary Mortgage Loan Database 116. As can be appreciated, the underlying basis of obtaining reliable outcomes from executing risk assessment models—CORAL Model 212 and PLATES Model 211 depends on being able to use realistic data to construct these models prior to execution on a current mortgage loan or portfolio submitted by a bank or a financial institution. As a result, variables used in these models are derived from historical loan data (Historical Mortgage Data 204) stored in Proprietary Mortgage Loan Database 116. Historical Mortgage Data 204 comprises data from historical mortgage loans that have been marked as fraudulent as well as those that are non-fraudulent.

After risk assessment models are created, these models are executed on a given mortgage loan to arrive at an outcome (a risk score). Outcome of executing CORAL Model 212 and PLATES Model 211 on mortgage loan data that has been normalized and analyzed (underwritten) is saved in CORAL Database 214 and PLATES Database 213 respectively to be communicated via a network 150 to banks and financial institutions using a Front End Export Results Module 125.

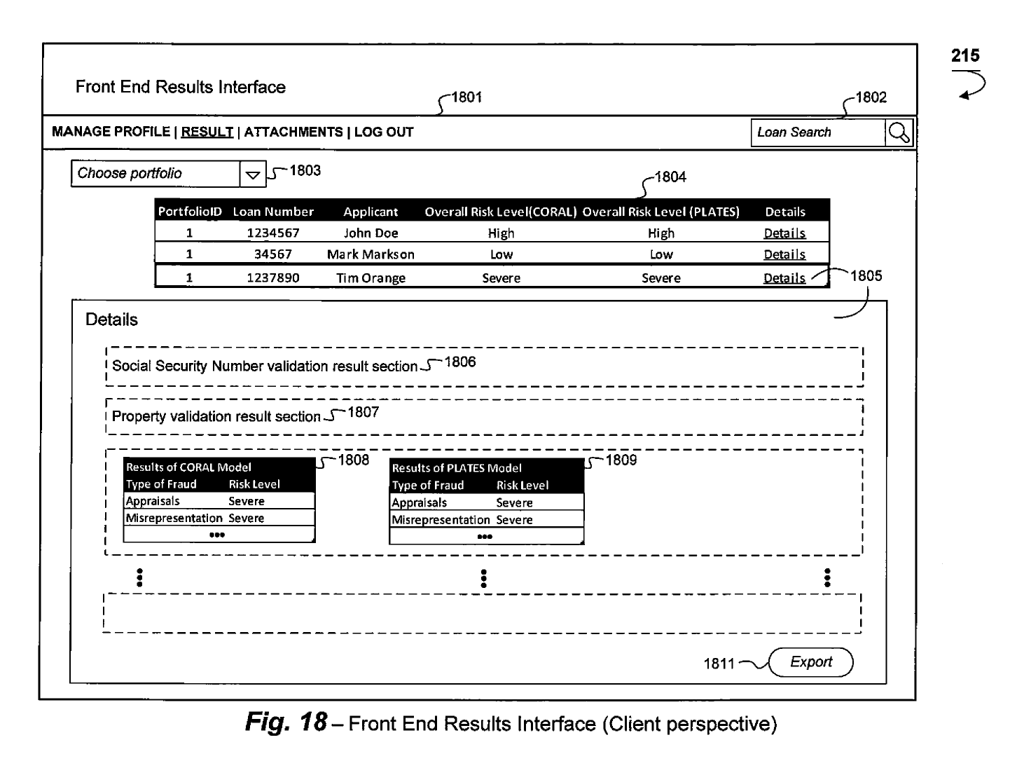

Front End Export Results Module 125 (described in detail in FIG. 11) comprise CORAL Database 214 and PLATES Database 213 and a Front End Export Results Interface 215 (shown with an exemplary screenshot in FIG. 18). An individual working for a bank or financial institution uses Front End Export Results Interface 215 to review and export outcome of risk-assessment (result of MFDS processing) according to the steps described in FIG. 12. Outcomes of risk-assessment performed on mortgage loan are used by banks and financial institutions to decide whether or not to grant a mortgage loan to an applicant 101, and can also be utilized by portfolio managers 113 working at financial institutions 112A for purposes of identifying problem loans within a loan portfolio 110 and take appropriate actions accordingly.

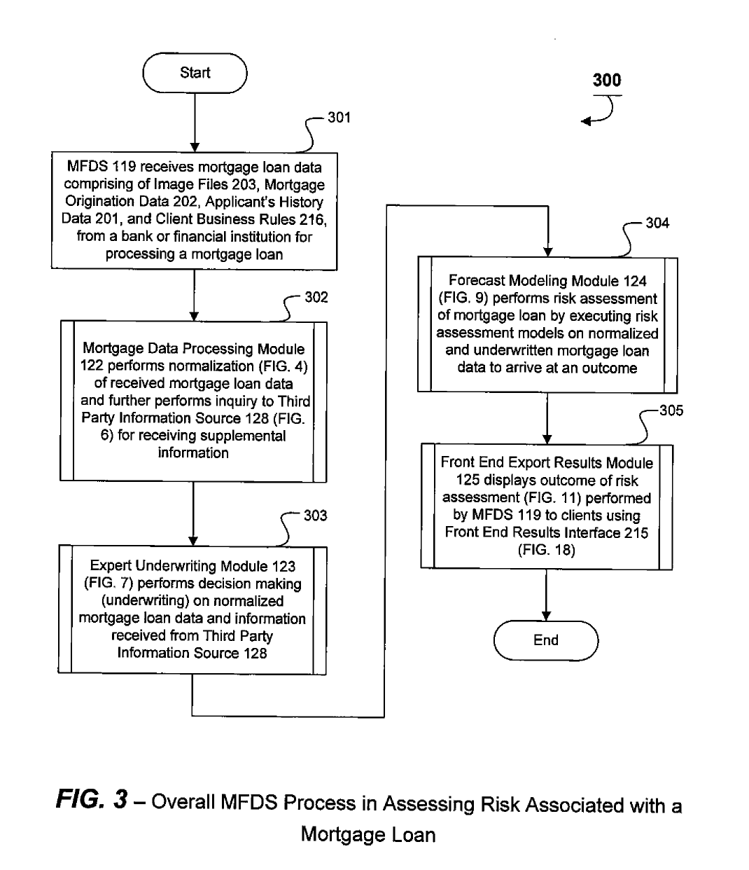

Now turning to FIG. 3, a flowchart 300 is shown illustrating an exemplary operation of MFDS 119 as it processes a mortgage loan and executes risk assessment models in order to arrive at a risk score and level of risk (for example, high/medium/low etc.) associated with a mortgage loan that is submitted by a bank or financial institution. Those skilled in the art will understand and appreciate that the process 300 is also applicable to assess risk with mortgage loans in a loan portfolio, and even further to assess risks associated with any kind of financial instrument. As will be understood, several high-level steps in this flowchart are completed in the order shown and some of the steps have been further exploded in greater detail in flowcharts that follow.

According to one embodiment of the present disclosure, MFDS processing involves processing of mortgage loan data (submitted by banks and financial institutions) by various components and modules (Mortgage Data Processing Module 122, Expert Underwriting Module 123, Forecast Modeling Module 124, and Front End Export Results Module 125, in that order and as shown in FIG. 1). The outcome of such a processing is a risk score and a level of risk, in connection with said mortgage loan. It will be understood that MFDS Database stores raw mortgage loan data as submitted by banks and financial institutions initially before processing begins, and also during intermediate processing steps when various modules and components access either raw mortgage loan data as originally submitted, or in a partially processed form of mortgage loan data.

Furthermore, it will also be understood that MFDS Database stores the final outcome of processing a mortgage loan, i.e. a risk score and a level of risk (for example, high/medium/low etc.) associated with a mortgage loan that was originally submitted by a bank or financial institution. As will be understood, various risk assessment models in Forecast Modeling Module 124 are used to predict a risk score and level of risk in connection with a mortgage loan. It will be recalled that variables used in constructing risk assessment models are derived from historical mortgage loans (Historical Mortgage Data 204 shown in FIG. 2) stored a Proprietary Loan Database 116. Those skilled in the art will understand and appreciate that the outcome of processing a current mortgage loan can additionally be stored in Proprietary Loan Database 116 to be used as variables in construction of risk assessment models for the future.

Referring to FIG. 3, starting at step 301, MFDS 119 receives mortgage loan data from client (mortgage origination bank 103 or financial institution 112A) for processing. As mentioned earlier, this data comprises Applicant History Data 201, Mortgage Origination Data 202, Image Files Data 203 and Client's Business Rules 216. At step 302, Mortgage Data Processing Module 122 performs normalization and Third Party Information Source 128 inquiry on received mortgage loan data as explained in detail in FIG. 4 and FIG. 6 respectively. Third Party Information Sources 128 like credit bureau agencies, bankruptcy courts, government agencies such as the FDIC, LexisNexis, MAVENT and MERS (Mortgage Electronic Registration System), and the like provide additional information that is utilized by the system to assess risk associated with a given mortgage loan. Although not shown here, after normalization and inquiry to a Third Party Information Sources 128, an internal analyst inspects the normalized mortgage loan data as explained in FIG. 5.

At step 303, Expert Underwriting Module 123 (the workings of which are explained in FIG. 7 in greater detail) performs underwriting as explained in FIG. 8 by looking for potential discrepancies in the normalized mortgage loan data, and then further classifying these discrepancies into pre-categorized types of mortgage fraud types, according to a Fraud Classification Table 220. Typical fraud types include appraisal, compliance, liability, mis-representation, occupancy, and other such fraud. Next, at step 304, Forecast Modeling Module 124 executes risk assessment models (CORAL Model 212 and PLATES Model 211) on normalized and underwritten mortgage data, according to the steps shown in FIG. 9. Although not shown here, the process of creating risk assessment models is explained in greater detail in FIG. 10. At next step 305, a Front End Export Results Module 125 provides outcome of execution of risk assessment models to clients, viz. banks or financial institutions, according to the steps shown in FIG. 11, through a Front End Results Interface 215 (shown with an exemplary screenshot in FIG. 18). As can be understood by a person skilled in the art, only certain individuals working at client institutions are authorized to review and export result (as shown in FIG. 12) of risk assessment.

Turning now to FIG. 4, a flowchart is shown illustrating computer-implemented steps performed in normalization of mortgage loan data, from the perspective of Mortgage Data Processing Module 122. Those skilled in the art will understand and appreciate that the system and methods discussed herein can be used to analyze any type of financial instruments and is not limited to single mortgage loans or loan portfolios. According to one aspect, normalization process includes creating a correct mapping between columns in a mortgage data file provided by banks and financial institutions, to the appropriate corresponding columns in MFDS Database 126. According to another aspect, the normalization process is associated with validating the datatype of every entry in the mortgage data provided by clients. The reason for such a validation is explained with an example as follows. In an exemplary operation at a client bank or financial institution, an inadvertent error occurs wherein a mortgage loan value (which is a numerical quantity) is recorded by clients in an electronic mortgage data file as a string of characters. As will be understood by a person skilled in the art, such an error needs to be detected and corrected to prevent future issues arising out of this error. In other words, mortgage loan value needs to be recorded as a numerical quantity instead of a string of characters. Thus, the datatype of every entry in a mortgage data file provided by clients is validated in order to locate any such errors.

Starting at step 400, Mortgage Data Processing Module 122 processes received Image Files 203. As mentioned previously, Image Files 203 comprise actual mortgage loan documents in electronic form and/or scanned images thereof, received from banks or financial institutions. These files are processed in order to make that information useful in the various processes. According to one embodiment, processing involves the steps of (a) scanning individual loan documents (if they have not been scanned already) (b) creating a single loan document, by merging individually scanned loan documents, (c) indexing (bookmarking) locations of the individual documents within the single loan document, (c) storing the indexes (bookmarks) that point to the individual loan documents in an “indexing table” (as shown in exemplary Attachment Table 1305 in FIG. 13), and (d) using text recognition programs on the single loan document to make it searchable. Such an indexing table described above contains the location of the image file on the storage disk, and associated mortgage loan identifier which identifies the mortgage loans that the image files are associated with.

After Image Files 203 has been processed, Mortgage Data Processing Module 122 is invoked by an analyst through Import Data Interface (IDI) 217 (shown with the help of an exemplary screenshot in FIG. 16). At step 401, Mortgage Data Processing Module 122 receives a request to authenticate analyst's credentials after receiving such a request from an analyst.

As recited previously, data in a mortgage file received by MFDS 119 comes from heterogeneous sources—a variety of banks and financial institutions each following their own file format (Microsoft Word, Microsoft Excel, Adobe PDF, etc.) or a formatted text file. Further each bank or financial institution has their own policy of acquiring, storing, using and redistributing the data. For example, banks have their own way of naming columns that store applicant data. A bank can store an applicant's first name under a column named “frame” whereas another bank can store such data under a column named “FIRST-NAME”. Thus normalization of the received loan data into a common format allows in receipt, storage, accumulation, and utilization of information from various disparate (heterogeneous) loan sources. This is better understood with the following example.

A fictitious applicant “John Doe” applies for a loan from a fictitious bank (“ABC Bank”) that stores the first name of the applicant (the string of characters “John” in this example) in a mortgage file named fictitiously as “Myfile_abc.xls” under a column named “F_NAME”. Also, for example, MFDS Database 126 stores first name of an applicant under a column named “FIRST_NAME” in a table named “Applicant”.

Although not shown here, it will be understood that a proprietary template file provides instructions to Mortgage Data Processing Module 122 to map columns (and subsequently save) and corresponding entries in client provided mortgage file to columns in and corresponding entries in MFDS Database. Referring to the above mentioned example, the column named “F_NAME” in “Myfile_abc.xls” is mapped to the column named “FIRST_NAME” in a table named “Applicant” in MFDS Database 126. Further, proprietary template file also indicates the type of data that is stored in those columns, which, in this example, is a string of characters. This example can be further understood with the help of the Import Data Interface 217 in exemplary screenshot provided in FIG. 16.

As will be seen from FIG. 16, column names in client-provided mortgage data file are “MortgageID”, “Mort_Amount”, “F_NAME”, “L_NAME”. These columns are listed under “Mortgage File Column Name” (region 1617 in IDI 217). After normalization is performed, “Mortgage File Column Name” and its entries are mapped into “MFDS Column Name” (region 1608) and its respective entries. In other words, after normalization is performed “F_NAME” is mapped onto “FIRST_NAME”, “L_NAME” is mapped onto “LAST_NAME”, etc. Instructions of such a mapping, as explained in the above example, is provided in a proprietary template file.

Proprietary Template file is a document containing instructions of normalization process—mapping information between columns in mortgage data file provided by banks and financial institutions, to appropriate corresponding columns in MFDS Database 126. As will be understood, additional mapping details are also contained in a proprietary template file—name of data tables (in MFDS Database 126) where a particular type of mortgage data is to be stored and also the type of data (string, number, etc) to be stored in those columns. It will be further understood that MFDS 119 can have multiple proprietary template documents directed towards mapping data received from multiple clients. Further, even for a given client, there could be several proprietary template documents depending on several factors, for example, the kind of mortgage—residential, commercial or other such factors.

Still referring to FIG. 4, once an analyst's credentials has been authenticated by the system, the system waits for an analyst's entry (at step 402) to enter information required to perform normalization comprising selecting a client (a bank or financial institution whose data needs to be imported into MFDS Database 126), a proprietary template file pre-stored in MFDS Database, and a mortgage file (containing data related to a particular mortgage loan associated with a particular client). Subsequently after an analyst has entered the information as described above, a request is received (at step 403) from an analyst to begin the process of importing columns (and data stored in those columns) from client provided mortgage data file to corresponding columns in MFDS Database 126.

At step 404, the system verifies whether an analyst has provided the required information: a client (bank or a financial institution) whose data needs to be imported into MFDS Database 126, a proprietary template document containing details of normalization (mapping) process, and a mortgage data file containing details of a particular mortgage loan, in connection with the selected client. In case the system does not receive the required information, the system displays an error message to the analyst as shown in step 406.

If at step 404, the system has successfully received the required information, then at next step 405 the system performs the normalization process of mapping columns in client provided mortgage data file to corresponding columns in MFDS Database 126, according to instructions provided in the proprietary template file. Details of the normalization process have been explained with an example above. Moreover, it will be understood and appreciated that a normalization process causes the data to be amenable for query and further processing by one or more Third Party Information Sources 128 like credit bureau agencies, bankruptcy courts, government agencies such as the FDIC, LexisNexis, MAVENT and MERS (Mortgage Electronic Registration System), and the like. These sources provide additional related and often unrelated third party data pertaining to particular borrowers, properties, credit records, court records, etc. Steps involved in performing a query and receiving a response is shown with a flowchart in FIG. 6.

Continuing with explaining the steps of FIG. 4, at step 407, the system displays results of normalization to an analyst. For example, it can be seen from FIG. 16 that “MortgageID” in client provided mortgage data file is mapped onto “LoanNumber” in MFDS Database 126 as a results of an exemplary normalization. At next step 408, in FIG. 4, the system determines whether the normalization was successful or not. In other words, whether there is a mismatch in the normalization process resulting in column(s) in client provided mortgage data file not mapping to the appropriate column(s) in MFDS Database 126. This happens, for example, when one or more columns in client provided mortgage data file does not have a “counterpart” column in MFDS Database 126, or vice-versa. In case there is a mismatch, the system displays such a mismatch (by highlighting mismatched data) to analyst at step 409 and waits for analyst's entry to rectify mismatch at following step 410.

In case the mapping process was successful (no mismatch), or after the mismatch was rectified by analyst, the system waits for analyst's entry to invoke a validation process at step 411. Mortgage Data Processing Module 122 performs the validation process at step 412, during which it determines datatype of every data entry in every column of the client provided mortgage data file. For example, every data entry in an exemplary column named “Social Security Number” should be integers, or for example, every data entry in an exemplary column named “F_NAME” should be a string of characters. At step 413, the system determines whether the validation process was successful or not, i.e. a data entry in a column of client provided mortgage file conforms with other data entries in the same column or not. In case validation was not successfully performed, the system displays an error message to the analyst at step 406, and then restarts the normalization process at step 402.

If at step 413 (referred in FIG. 4) validation is successfully performed, then at next step 414 the system waits for a request from an analyst to invoke an end of import process (that started in earlier step 403). The end of the import process results in the system copying data from client provided mortgage file to corresponding columns in MFDS Database 126. After (validated) data from client provided mortgage file has been copied into MFDS Database 126, Mortgage Data Processing Module 122 performs an inquiry at step 416 with a Third Party Information Source 128 (and described in detail in FIG. 6) in connection with current mortgage data to obtain additional related and often unrelated third party information. Examples of Third Party Information Sources 128 include credit bureau agencies, bankruptcy courts, government agencies such as the MAVENT, LexisNexis, MERS (Mortgage Electronic Registration System), and the like. After a response has been received from one or more Third Party Information Sources 128 and subsequently processed, at step 417 the Mortgage Data Processing Module 122 flags current mortgage data as ready to be processed by Expert Underwriting Module 123. Details of the steps performed by a human analyst involving inspection of normalization process are explained below.

Referring now to FIG. 5, a flowchart is shown illustrating steps of a process 500 performed by a human analyst (using an exemplary interface discussed in FIG. 16) involving an inspection and review of a normalization process. (Details of normalization process are discussed in FIG. 4.) As will be understood, an analyst reviews various columns in client provided mortgage data file, and the appropriate mapping of those columns to the corresponding columns in MFDS Database 126. Thus, as can be seen from exemplary interface shown in FIG. 16, an exemplary column entitled “MortgageID” in client provided mortgage data file is mapped to a corresponding “LoanNumber” column in MFDS Database. Steps taken by an analyst are described below.

Starting at step 501, an analyst converts client institution's policies (Client's Business Rules 216) into a configuration file that is compatible with MFDS 119. As recited previously, Client's Business Rules 216 comprise corporate policies defined by respective clients (banks and financial institutions) that generally govern how mortgage loans are to be processed. Typically, these policies state requirements deemed relevant by a particular client that are needed to qualify a mortgage loan. These policies also include relationships within different components of a mortgage loan. For example, a business rule states that if an applicant's last name is provided, then a first name of the applicant should be provided. Another example of a policy is if an applicant's income is less than a first predetermined value and the loan amount applied for is greater than a second predetermined value, a minimum of two guarantors are needed to qualify for that loan. According to one aspect, policies are provided in a Microsoft® Excel® file, and a configuration file is a formatted XML file. As can be understood, policies can be provided in other file formats as well. Similarly, various file formats can be used to create configuration files.

At next step 502, the analyst saves the configuration file in MFDS Database 126 to be utilized by Expert Underwriting Module 123 and Forecast Modeling Module 124. At step 503, the analyst logs in Import Data Interface (IDI) 217 (shown with a screenshot in FIG. 16). As can be seen from FIG. 16, an analyst reviews various columns in client provided mortgage data file, and the appropriate mapping of those columns to the corresponding columns in MFDS Database 126. Thus, as can be seen from exemplary interface shown in FIG. 16, an exemplary column entitled “MortgageID” in client provided mortgage data file is mapped to a corresponding “LoanNumber” column in MFDS Database. In another exemplary instance that can be seen from FIG. 16, a “Mort_Amount” column in a client provided mortgage data file is mapped into a “LoanAmount” column in MFDS Database.

Referring to FIG. 5, at step 504, an analyst with proper authorization credentials chooses a client whose mortgage data is to be normalized by Mortgage Data Processing Module 122 according to instructions provided in a proprietary template file. As recited previously, a proprietary template file contains mapping information between columns in mortgage data file provided by banks and financial institutions, to corresponding columns in MFDS Database 126. Although not shown in FIG. 5, it will be understood that internal analysts authorized to access MFDS 119 are allowed to perform inspection and review of normalized mortgage loan data. Next, at step 505, the analyst selects a proprietary template file and then at step 506, the analyst selects a mortgage file that needs to be normalized.

After providing information to Mortgage Data Processing Module 122 (at steps 504, 505, and 506) necessary for normalization, at step 507, the analyst invokes import of columns and data entries in those columns into MFDS Database 126, by clicking on button 1606 in FIG. 16. Consequently, Mortgage Data Processing Module 122 begins import process, and thereby performs normalization as explained in FIG. 4.

At step 508, the analyst inspects results of normalization (shown for example in region 1617 in FIG. 16). Accordingly, at step 509, the analyst is able to view whether or not a mismatch (in normalization) was reported by Mortgage Data Processing Module 122. As recited previously, this happens for example, when one or more columns in client provided mortgage data file does not have a “counterpart” column in MFDS Database 126, or vice-versa. In case of a mismatch, the analyst inspects normalization mismatch and accordingly corrects it, at step 510. If there was no mismatch reported in step 509, or if mismatch occurs and the analyst corrects such a mismatch in step 510, then at next step 511 the analyst invokes a validation process.

Validation process is performed by Mortgage Data Processing Module 122, during which the system determines datatype of every data entry in every column of client provided mortgage data file. At following step 512, the analyst is able to review whether or not error is returned in the validation process. An error occurs in the validation process when one or more data entries in one or more columns in client provided mortgage file do not have identical datatype. In case of error(s), the analyst views an error message displayed by the system, at step 513, and the normalization process restarts from step 506 again. If no errors are reported, the analyst ends import process (at step 514) that was started previously at step 507.

Now referring to FIG. 6, a flowchart is shown illustrating a sequence of steps 416 performed by Mortgage Data Processing Module 122 in performing an inquiry to a Third Party Information Source, and further processing a received response. As recited previously, Third Party Information Sources 128 provide additional related (to mortgage loan) and often unrelated third party information. Such information includes automated valuation models, compliance and regulatory agencies, credit bureau agencies, bankruptcy courts, government agencies such as the FDIC, Bureau of Labor Statistics, MAVENT, MERS (Mortgage Electronic Registration System), LexisNexis, and the like. Although FIG. 6 has been described to mortgage loan data, those skilled in the art will understand and appreciate that the system and methods discussed herein can be used to analyze any type of financial instruments and is not limited to single mortgage loans or a bundle of mortgage loans in a loan portfolio.

Starting at step 601, Mortgage Data Processing Module 122 retrieves data (pertaining to a mortgage loan) from MFDS Database 126 for which inquiry is performed, and then at step 602, the system generates a query configuration file containing one or more queries for specific information relating to specific borrowers, properties, lenders, guarantors, and the like. Query configuration file comprises unique identification data fields that identify the borrowers (for example: first name, last name, date of birth, social security number, etc.) and properties (for example: street address of the property). According to one embodiment, the unique identification data fields are provided in the form of a matched information stream. As recited previously, query configuration file also includes parameters for which additional unrelated (to mortgage loan) information is requested from Third Party Information Source 128.

Third Party Information Source 128 provides feedback with information that pertain to the borrowers (for example: personal bankruptcy records, applicant's personal income records, lien and judgment records, credit bureau reports, social security name look up records, addresses and time periods for the specified person, etc.) and information that pertain to the property (for example: names and periods of persons that are associated with the property, retroactive asset valuation estimate, historical sales records of subject property, historical sales records of properties sales in the surrounding area, etc.). As can be understood, such information provides additional knowledge about an applicant (including applicant's financial history) and the property in question, in addition to mortgage loan data provided by bank or financial institution. Consequently, such information would be utilized by Forecast Modeling Module 124 (FIG. 9) to generate risk scores that would be useful for a bank or financial institution in making an informed decision on how much risk is associated in granting a mortgage loan to an applicant in connection with the property in question.

Further, Third Party Information Source 128 provides various kinds of public as well as non-public data that are utilized in creating mortgage risk-assessment models by Model Building Module 218 (FIG. 9). Still referring to FIG. 6, at step 603, configuration file generated in previous step is transferred to a remote Third Party Information Source 128. According to one aspect, configuration file is an XML file, although no such limitation exists and configuration file can have other file formats as well. As will be understood by one skilled in the art, Third Party Information Source 128 receives said query configuration file and processes it. Processing a query configuration file involves parsing the file, and aggregating information requested by Mortgage Data Processing Module 122. Further, a response configuration file is generated by Third Party Information Source 128 containing a response created from the aggregated information. Third Party Information Source 128 then transfers said response configuration file to Mortgage Data Processing Module 122. As can be understood by a person skilled in the art, an electronic file transfer is subjected to several kinds of errors. For example, a “Not Found 404” error indicates that Third Party Information Source could not be found as requested by Mortgage Data Processing Module 122. Another example of an error occurring during file transfer is an “Unexpected Condition 500” error which indicates that Third Party Information Source 128 encountered an unexpected condition, and was unable to fulfill request of providing a response to Mortgage Data Processing Module 122. Such types of errors occurring during transfer of response configuration file are checked at step 607. If an error happens in transfer, transfer session is usually aborted. If there was no error in transfer of said response configuration file, then this file is correctly received by Mortgage Data Processing Module 122 at step 608. In case of an error in transfer, transfer session is aborted.

After receiving said response configuration file, Mortgage Data Processing Module 122 parses response configuration file (at step 609) to extract response. As can be understood by a person skilled in the art, response configuration file can be subjected to errors causing the file being unable to be read. Alternatively, in many situations, extracted response indicates that Third Party Information Source 128 is busy and hence requested information is unavailable. As a result, at step 610 Mortgage Data Processing Module 122 checks whether said response configuration file is invalid or not. In case the response configuration file is invalid, Mortgage Data Processing Module 122 schedules a retry (at step 611) by attempting to retrigger the whole process beginning from step 601.

If a response configuration file is not invalid, then data provided in response configuration file is processed at step 612. As can be understood, loan information received from various Third Party Information Sources 128 constitutes disparate and often heterogeneous data. This received data is processed first (for example, mapping the columns in the response configuration file to columns in MFDS Database 126) in order to transform the data into a consolidated and homogenized format, before being saved in MFDS Database 126. The response received from Third Party Information Source 128 is used in underwriting process by Expert Underwriting Module 123 as explained below.

Referring now to FIG. 7, a flowchart is shown illustrating computer-implemented steps taken by an Expert Underwriting Module 123 for performing an underwriting process, and further providing appropriate data displays/prompts (through an Underwriting Information Process) for a human underwriter (internal analyst) to interact with Expert Underwriting Module 123. Starting at step 701, Expert Underwriting Module 123 receives an analyst's credentials through Underwriting Information Interface 206 (shown with a screenshot in FIG. 17) to authenticate an analyst. After an analyst has been authenticated, Expert Underwriting Module 123 waits for the analyst to choose a mortgage loan that needs to be analyzed and/or underwritten.

Once the analyst has chosen a loan, Expert Underwriting Module 123 retrieves (at step 703) normalized and validated mortgage loan data (normalized and validated by Mortgage Data Processing Module 122) from MFDS Database 126. Next, at step 704 Expert Underwriting Module 123 applies a client institution's corporate policies (Client's Business Rules 216) to normalized and validated mortgage loan using configuration file (created in FIG. 5) to arrive at a first data set. As recited previously, Client's Business Rules 216 comprise one or more policies defined by respective clients (banks and financial institutions) that generally govern how mortgage loans are to be processed. For example, a policy can specify a maximum mortgage loan for an applicant depending on applicant's income. These policies generally differ from one client to another.

As recited previously, underwriting process involves analyzing mortgage loan data along with supplemental data received from Third Party Information Sources 128 supplemental to mortgage loan data (typically referred to as origination data) received from banks and financial institutions. Steps involved in processing an inquiry and receiving a response from a Third Party Information Source are shown in FIG. 6. At step 705, Expert Underwriting Module 123 detects discrepancies by comparing information stated in normalized mortgage data, data received from Third Party Information Source 128, and first data set containing Client's Business Rules 216 as explained above. As will be understood by those skilled in the art, comparing information stated in multiple data sets involves parsing such data sets, and detecting inconsistencies in particular data fields in those data sets. In an exemplary instance, Expert Underwriting Module 123 parses mortgage origination data provided by an applicant's bank to obtain the applicant's Social Security Number. Further, Expert Underwriting Module 123 parses the response received from a Third Party Information Source 128 to obtain applicant's Social Security Number. In the event that there is a mismatch of the applicant's Social Security Number as obtained from the above mentioned data sources, Expert Underwriting Module 123 flags this mismatch (or, more generally, inconsistency) as a discrepancy.

Detecting discrepancies in mortgage data further involves classifying (at step 706) a discrepancy to a pre-categorized mortgage fraud type listed in a Fraud Classification Table 220. As recited previously, Fraud Classification Table 220 comprises a plurality of fraud types relevant to mortgage loans. Typical fraud types include appraisal, compliance, liability, mis-representation, occupancy, and other such fraud. According to one embodiment, the system automatically provides a pre-determined supporting reason (listed along with associated pre-categorized fraud type) from Fraud Classification Table 220.

Next, at step 707, Expert Underwriting Module 123 displays detected fraud types along with associated pre-determined supporting reason fraud types to a human underwriter. In addition, contents of information in normalized mortgage data, supplemental data received from Third Party Information Sources 12 are also displayed to a human underwriter. Display of this information to analyst is performed via Underwriting Information Interface 206 (FIG. 17), and subsequently at step 708 the system waits for an entry from analyst (human underwriter) through Underwriting Information Interface 206.

A human underwriter performs visual inspection for discrepancies and associated fraud types. In addition to visually inspecting discrepancies (if any) in mortgage data presented on the Underwriting Information Interface (FIG. 17), human underwriter performs calculations as necessary on the numerical information associated with mortgage loan (for example, calculating monthly mortgage payment on a previous loan for an applicant) and verifying this in association with other submitted documents available in electronic and/or hand-written form. Further, an underwriter can also visually detect additional discrepancies and hence render decisions by classifying additional discrepancies into pre-categorized fraud types as listed in a Fraud Classification Table 220 and further provide supporting reason for such discrepancies. Moreover, an underwriter can review and edit pre-existing discrepancies, including add/delete documents attached with pre-existing discrepancies.

As will be understood from the following steps in the flowchart of FIG. 7, an underwriter provides an entry belonging to a set of pre-determined events, for example, adding a discrepancy, deleting a discrepancy, etc. The system, in turn performs a sequence of steps to determine the event associated with this entry. Next, the system performs tasks associated with said event, and after completion of such tasks, reverts back to step 708. For example, if an underwriter wishes to delete a discrepancy, the underwriter clicks on “Delete” button 1711 on the Underwriting Information Interface 206. The system receives such a click, performs a sequence of steps in order to determine the event (in this example, deleting a discrepancy) associated with such a click. Then, it performs tasks associated with deleting a discrepancy, and after the tasks are complete, the system reverts back to step 708. This will be better understood in the detailed description of FIG. 7 given below.

At step 708, the system waits for an analyst to enter information through Underwriting Information Interface 206. After an underwriter (analyst) has made an entry through Underwriting Information Interface 206, the system receives the analyst's entry at step 709. Then, the system performs a sequence of steps (as explained below) to determines the event associated with the analyst's entry.

First, at step 710, the system determines if the analyst's entry relates adding (specifying) one or more discrepancies in current mortgage loan. In other words, the system determines whether or not the analyst's entry was due to analyst clicking on “Add Discrepancy” (button 1706). If the system determines that analyst has indeed clicked on “Add Discrepancy”, then it waits for analyst (at step 711) to specify (add) a discrepancy and supporting reason for such a discrepancy. Specifying a discrepancy (by an analyst) comprises the steps of assigning a discrepancy to a pre-categorized type of fraud as listed in Fraud Classification Table 220, and providing a supporting reason for such a discrepancy.

After the analyst has specified one or more discrepancies along with supporting reason for such discrepancies, the system saves such discrepancies entered by analyst along with supporting reason in Decisioning Database 205 at step 712. Subsequently, the system reverts back to step 708 and waits for analyst to re-enter information again, and the process continues.

As can be understood by a person skilled in the art, an analyst can also re-investigate a mortgage loan that has been previously underwritten. In other words, an analyst can review and edit (if necessary) a pre-existing discrepancy. Thus, at step 713 the system proceeds to check whether the event for an analyst's entry is from editing a pre-existing discrepancy (“Edit” button 1710). If the system determines at step 713 that the event for an analyst's entry is for editing a pre-existing discrepancy, then at next step 714, pre-existing discrepancy is displayed in edit mode to the analyst, to be edited by the analyst. Next, at step 715, the system waits for the analyst to edit pre-existing discrepancy by (a) re-assigning it to some other pre-categorized fraud type listed in Fraud Classification Table 220, and/or (b) making changes to the text in the supporting reason of pre-existing discrepancy. After the analyst has edited pre-existing discrepancy, the system receives these edits in discrepancy entered by the analyst at step 716, and saves such edits in Decisioning Database 205 at step 712, along with supporting reason for discrepancy. Subsequently, the system reverts back to step 708 and waits for the analyst to re-enter information again.

If the system determines at step 713 that the event for an analyst's entry is not for editing a pre-existing discrepancy, then (at next step 717) the system checks whether the event for an analyst's entry is for deleting a pre-existing discrepancy (button 1711). If the system determines that the event for an analyst's entry is for deleting a pre-existing discrepancy, then the discrepancy is deleted (at step 718) along with supporting reason from the Decisioning Database 205. Subsequently, the system reverts back to step 708 and waits for the analyst to re-enter information again, and this process continues.

Alternatively, if the event for analyst's entry is not for deleting a pre-existing discrepancy, then the system determines (at step 719) whether the event for an analyst's entry (i.e. “Attachments View” button 1714) is for displaying an electronic attachment (supporting documents associated with a mortgage loan) that has been linked along with a pre-existing discrepancy. If the system determines that the event for an analyst's entry is for viewing an electronic attachment, then the attachment is displayed to the analyst at step 720. An attachment associated with a mortgage loan contains specific evidence directed towards indicating that a particular mortgage loan is fraudulent. Such documents, received from banks and financial institutions are stored and indexed in MFDS Database 126, as explained in FIG. 4. After displaying the electronic attachment to the analyst, the system reverts back to step 708 and waits for the analyst to re-enter information again.

If the system determines at step 719 that the event for an analyst's entry is not for displaying an electronic attachment, then (at next step 721) the system checks whether the event for an analyst's entry is for deleting an electronic attachment that has been linked with a pre-existing discrepancy. If the system determines at step 721 that the event for an analyst's entry is for deleting an electronic attachment attached with a pre-existing discrepancy, then the attachment is deleted from the discrepancy at step 722. After deleting the electronic attachment from the discrepancy, the system reverts back to step 708 and waits for the analyst to re-enter information again, and this process continues.

If the system determines at step 721 that the event for an analyst's entry is not for deleting an electronic attachment, (at next step 723) the system proceeds to check whether the event for an analyst's entry is for linking (adding) a new attachment to a pre-existing discrepancy. If the system determines at step 723 that the event for an analyst's entry is for adding an attachment to a pre-existing discrepancy, then an attachment is linked (at step 724) to a pre-existing discrepancy. As can be understood, location (on storage disk) of an attachment can be obtained from the indexing information listed in the indexing table described earlier. Attachments are saved in Decisioning Database 205, after which the system reverts back to step 708 and waits for the analyst to re-enter information again,

Although not shown here, it is understood that Expert Underwriting Module 123 updates discrepancies and associated attachments and saves changes in Decisioning Database 205. As can be understood and appreciated, results of an underwriting process are utilized by Forecast Modeling Module 124 in executing risk assessment models on mortgage loans. Thus, at step 725, Expert Underwriting Module 123 maps presence or absence of pre-categorized fraud types in mortgage loan into numerical parameters to be utilized by Forecast Modeling Module 124. According to one aspect of the present disclosure, presence of a pre-categorized fraud type is marked with a number one (1), whereas absence of a pre-categorized fraud type is marked with a number zero (0).

As can be understood by a person skilled in the art, Expert Underwriting Module 123 performs the steps of underwriting mortgage loan thereby transforming mortgage data received from banks and financial institutions into another form suitable for processing (as explained in FIG. 9, 10) in connection with assessing risk associated with a mortgage loan. Steps performed by a human underwriter in visually inspecting underwriting process performed by Expert Underwriting Module 123 and providing suitable inputs through an Underwriting Information Interface 206 (FIG. 17) are explained below.

Referring now to FIG. 8, a flowchart illustrating a process 800 involved in visual inspection, review and analysis of a mortgage loan (in association with Expert Underwriting Module 123) is shown. As recited previously, an expert underwriter (analyst) visually inspects discrepancies (if any) in mortgage data presented on the Underwriting Information Interface 206 (FIG. 17), and verifies the underwriting process performed by Expert Underwriting Module 123 that is explained earlier in FIG. 7. Further, an underwriter can review and edit pre-existing discrepancies, and also add/delete documents as evidence supporting pre-existing discrepancies associated with a mortgage loan.

Starting at step 801, an underwriter logs into Underwriting Information Interface 206 using his credentials and selects a mortgage loan at step 802. After receiving the analyst's credentials, Expert Underwriting Module 123 retrieves selected mortgage loan. Expert Underwriting Module 123 then detects discrepancies in selected mortgage loan by comparing information stated in normalized mortgage loan data, data received from Third Party Information Source 128, and a first data set (FIG. 7) containing client institution's policies (Client's Business Rules 216). Client's Business Rules 216 comprise one or more policies defined by respective clients (banks and financial institutions) that generally govern how mortgage loans are to be processed. Detecting discrepancies in mortgage loan data also involves assigning a discrepancy to a pre-categorized fraud type listed in Fraud Classification Table 220.

Next, discrepancies (along with associated fraud types) are displayed to an analyst through an Underwriting Information Interface 206, shown with an exemplary screenshot in FIG. 17. An underwriter performs visual inspection of discrepancies at step 803. An example of a discrepancy is an invalid zip code, mis-representation of Social Security Number, etc.

After Expert Underwriting Module 123 has displayed discrepancies, analyst determines at step 804 whether or not a new discrepancy is detected, in addition to discrepancies detected by Expert Underwriting Module 123. In case no discrepancy is detected at step 804, underwriter verifies whether inspection of entire mortgage loan is complete or not at step 816. In case a mortgage loan has been inspected entirely, underwriter logs out of Underwriting Information Interface 206 or proceeds to inspect another mortgage loan. If inspection is not complete, underwriter proceeds to next portion of mortgage loan at step 817, and restarts the inspection process at step 803.

If an underwriter detects additional discrepancy in mortgage data at step 804, then at step 805 an analyst specifies (adds) a discrepancy to a mortgage loan by assigning a discrepancy to a pre-categorized type of fraud as listed in Fraud Classification Table 220, and providing a supporting reason for such a discrepancy. As recited previously, Fraud Classification Table 220 comprises a plurality of fraud types relevant to mortgage loans. Typical fraud types include appraisal, compliance, liability, mis-representation, occupancy, and other such fraud. As recited previously, in addition to inspecting for new discrepancies an analyst can edit/delete a pre-existing discrepancy associated with a mortgage loan. Further an analyst can add/view/delete an attachment (a mortgage loan document associated with current mortgage loan received from bank or financial institution) linked with a discrepancy. This will be better understood in the steps that follow.

At step 806, an analyst decides whether to edit a pre-existing discrepancy or not. If an analyst chooses to edit a pre-existing discrepancy, then at step 807 the analyst inspects and edits a pre-existing discrepancy. For example, an analyst can change a fraud type associated with a pre-existing discrepancy to a different fraud type (as listed in Fraud Classification Table 220). Subsequently, the underwriter verifies whether inspection of entire mortgage loan is complete or not at step 816, and proceeds to a following step as indicated previously.

If an analyst does not want to edit a pre-existing discrepancy, then at step 808 the analyst determines whether to delete a pre-existing discrepancy or not. If an analyst chooses to delete a pre-existing discrepancy associated with a mortgage loan, the analyst deletes pre-existing discrepancy (by clicking on “Delete” button 1711 in FIG. 17). Consequently, Expert Underwriting Module 123 deletes pre-existing discrepancy (along with supporting reason from Decisioning Database 205). Next, the underwriter verifies whether inspection of entire mortgage loan is complete or not at step 816, and proceeds to a following step as indicated previously.

If an analyst neither wants to edit nor delete a pre-existing discrepancy, the analyst decides whether to view an attachment linked to a discrepancy at step 810. As recited previously, an attachment is linked to a mortgage loan and contains specific evidence directed towards indicating that a particular mortgage loan is fraudulent. Such documents, received from banks and financial institutions are stored and indexed in MFDS Database 126, as explained in FIG. 4. In case an analyst chooses to review an attachment, the analyst reviews the attachment at step 811. Then, the analyst verifies whether inspection of entire mortgage loan is complete or not at step 816, and proceeds to a following step as indicated previously.

An analyst can also choose to delete or add an attachment linked to a pre-existing discrepancy. At step 812, an analyst determines whether or not to delete an attachment linked to a pre-existing discrepancy, and accordingly, at step 813 the analyst deletes attachment linked to a pre-existing discrepancy. As can be understood, deleting an attachment does not cause the underlying document (that forms the basis of attachment) to be deleted from MFDS Database 126. Deleting an attachment removes the linkage between a discrepancy and an attachment. After deleting an attachment linked to a pre-existing discrepancy, the analyst then verifies whether inspection of the selected mortgage file is complete or not (step 816), and proceeds to a next step accordingly.

At step 814 the analyst decides whether or not to add an attachment to a pre-existing discrepancy, and thereafter adds an attachment to a pre-existing discrepancy at step 815. As indicated previously after adding an attachment, the analyst determines at step 816 whether inspection is complete or not, and ends the inspection process accordingly. After the analyst has inspected underwriting process Expert Underwriting Module 123 performs numerical operations (as described in FIG. 7) to transform underwritten mortgage data into a form suitable to be used by Forecast Modeling Module 124, in forecasting risk(s) associated with a mortgage loan, and saves the result of such operations in MFDS Database 126.

Referring now to FIG. 9, a flowchart illustrating steps 900 performed by Forecast Modeling Module 124, in forecasting risk(s) associated with a mortgage loan by executing proprietary mortgage risk assessment models (creation of these models are described in detail in FIG. 10) on normalized and underwritten mortgage loan data, is shown. One of such models is a CORAL Model 212, which is a statistical model that finds statistically significant scores (weights assignments) to be assigned to public data fields to indicate the propensity of a loan having fraud or mis-representation contents. A second type of forecast model is a PLATES Model 211 which is a statistical model that finds statistically significant weight assignments to be assigned to both public data fields and non-public data fields to indicate the propensity of a loan having fraud or misrepresentation contents. Examples of public data fields include mortgage loan amount, property type, unemployment rate, occupation wage, etc. Examples of non-public data include number of previous bankruptcies applicant has been involved with, difference between the property appraisal price and the sales price etc. An exemplary datatable showing representative data fields used in modeling CORAL Model 212 and PLATES Model 211 is shown in FIG. 15.

Risk assessment models are forecast models that can be utilized by both loan officers 104 working at a bank 103 to decide whether or not to grant a mortgage loan to an applicant 101, and can also be utilized by portfolio managers 113 working at financial institutions 112A for purposes of identifying problem loans within a loan portfolio 110 and take appropriate actions accordingly.

Starting at step 901, a mortgage loan whose outcome needs to be forecast is retrieved from MFDS Database 126. As recited previously, mortgage loan data received from banks and financial institutions is first normalized by Mortgage Data Processing Module (FIG. 4), and the results of the normalization are inspected by a human analyst (FIG. 5). Then, the normalized mortgage loan is underwritten by an Expert Underwriting Module 123 (FIG. 7) in association with a human analyst (FIG. 8) for detecting discrepancies in mortgage data, and thereby assigning said mortgage loan to one or more pre-categorized fraud type(s).

Parameters obtained from an underwriting process are used by a PLATES Model 211 as described in FIG. 10, at step 902, retrieved mortgage loan is saved in Modeling Database 207 for purposes of applying risk assessment models to this mortgage. At following step 903, Forecast Modeling Module 124 checks whether risk assessment models pre-exist in MFDS Database 126 or not. In case risk assessment models do not pre-exist, they are first created at step 904 by Model Building Module 218. Creating a model implies computing statistical weights (coefficients) that reflect statistical significance of various input parameters, and then combining input parameters and weights to evaluate the propensity of a loan having fraud or mis-representation contents (i.e. a probability of fraud associated with a loan). Details of steps associated with creating risk assessment models are described in detail in FIG. 10.

Still referring to FIG. 9, if pre-created risk assessment models exist in MFDS Database 126, or after such models have been created for the first time, a set of input parameters required by risk assessment models are selected from current mortgage loan and data received from Third Party Information Sources 128. Input parameters are the independent variables involved in a mortgage loan that determine the output (dependent variable) of a model. Output variable of a model includes a risk score (probability of fraud) associated with a mortgage loan. Input parameters selected for executing a risk assessment model are chosen to identical to the input parameters used in creating the model. Typical input parameters include (but not limited to) mortgage loan amount, income of applicant, number of guarantors in mortgage loan, value of real estate in area where applicant intends to purchase property etc.

Input parameters for executing both CORAL Models 212 and PLATES Models 211 involve public (macro-economic) data fields that are freely available to the public, and available from mortgage loan data received from banks and financial institutions as well as from Third Party Information Sources 128. Examples of public data include mortgage loan amount, property type, National Housing Sales Price, National Employment, Housing Price Index, etc. Thus, at step 905, a first set of input parameters comprising public data are selected from current mortgage loan as well from data received from Third Party Information Source 128 (according to the steps shown in FIG. 6), for both CORAL Model 212 and PLATES Model 211.

For executing a PLATES Model 211, in addition to public data, non-public data (that is not publicly available) and also parameters obtained from underwriting a mortgage loan (as shown in FIG. 8) are used. Public and non-public data are available from mortgage loan data received from banks and financial institutions as well as from Third Party Information Sources 128 (according to the steps shown in FIG. 6). An example of non-public data is number of years elapsed between the date when applicant's Social Security Number was issued and the mortgage origination date. Various non-public data include indicator (binary) variables that take the values of zero or one, depending whether or not verification of a condition was successful. Examples of verifiable conditions include a reverse phone look-up (matching a given phone number listed in the mortgage loan application to an applicant's name), a match between a state where the subject property resides and a state of issuance registered under an applicant's Social Security Number, and several other such variables. Consequently, a second set of input parameters comprising public, non-public data and parameters obtained from underwriting a mortgage loan are selected at step 912, for PLATES Model 211. Then, at step 913 first set of input parameters are combined with second set of input parameters to form an updated set of input parameters.

For both CORAL Model 212 and PLATES Model 211, input parameters selected are identical to the ones that were selected for creating the respective models, but taking on different values. When creating a model, values of input parameters and their corresponding outcomes are known from historical mortgages, whereas when executing a model, values of input parameters are obtained from current mortgage loan (whose outcome is to be predicted) and data received from Third Party Information Sources 128.

After the input parameters have been selected for the respective models, they are passed to a CORAL Model 212 at step 906 and a PLATES Model 211 at step 914. Then these models are executed (at steps 907, 915) to arrive at a risk score (probability of fraud) on a mortgage loan. Probability of fraud returned by CORAL Model 212 and PLATES Model 211 is expressed as a percentage value. As can be understood by a person skilled in the art, various other numerical quantities, different from probability of fraud can be computed to represent risk associated with a mortgage loan.

Risk score obtained from executing risk assessment models on a mortgage loan is further classified one of a plurality of predetermined risk levels (for example, Low, Medium, High and Severe fraud levels), based on the level of risk tolerance, a client bank or financial institution has indicated in a client's corporate business rules (Client's Business Rules 216). According to one embodiment, threshold values are used to quantify risk tolerance levels of a client. Thus, Client's Business Rules 216 available in a configuration file (created in FIG. 5 and stored in MFDS Database 126) are retrieved by Forecast Modeling Module 124 at steps 908 and 916 for both CORAL 212 and PLATES Models 211. Next, threshold values are read (at steps 909 and 917) from retrieved configuration file, for both CORAL 212 and PLATES Models 211, in order to classify probability of fraud predicted by CORAL 212 and PLATES Models 211 at steps 910 and 918 respectively into one of a plurality of predetermined risk levels. According to one embodiment, values of probability of fraud less than 50% are classified as low risk, probabilities greater than 50% and less than 70% are classified as medium risk, probabilities greater than 70% and less than 90% are classified as high risk, and mortgages having probabilities of fraud greater than 90% are associated with severe risk. Eventually, results obtained from both CORAL 212 and PLATES Models 211 are saved (along with their risk classification) in CORAL Database 214 and PLATES Database 213, at steps 911 and 919 respectively. Although FIG. 9 has been discussed with reference to mortgage loans, those skilled in the art will understand and appreciate that the system and methods discussed in executing risk assessment models can be applied to any type of financial instruments and is not limited to single mortgage loans or loan portfolios. The steps involved in the construction of risk assessment models is described next.

Now referring to FIG. 10, a flowchart illustrating steps involved in the construction of proprietary risk assessment models by a Model Building Module 218, for assessing risks associated with new mortgage applications as well as management of existing loan portfolios, is shown. During creation of both CORAL Models 212 and PLATES Models 211, statistically significant weights (coefficients) are computed for a set of input parameters (independent variables) selected from historical loans (Historical Mortgage Data 204) stored in a Proprietary Mortgage Loan Database 116. These weights are subsequently applied during execution of a model to input parameters (independent variables) obtained from mortgage data received from banks and financial institutions and Third Party Information Sources 128 to compute risk scores (for example, probability of fraud associated with a mortgage loan). As can be understood, although input parameters are identical for creation and execution of risk assessment models, they are assigned different values for creation and execution phases.

Input parameters characterize several different factors of a mortgage loan, e.g., different mortgage types, purpose of mortgage loan, etc. Different types of mortgages are characterized differently as it is expected that certain types of mortgages will have greater risks of fraud or mis-representation than others. Such different types of mortgages include a mortgage for a condominium, a mortgage for a primary residence, a mortgage for a vacation (second) home, a mortgage on an investment property, a mortgage on a combined residential and business property, a refinancing of any of these, etc. Each of these different types of mortgages receives a “property type” indicator as a part of the characterizing of the mortgage in the system, either as historical data on which the scoring model is built, or as new mortgage loan or existing portfolio management conducted by a customer of the system. Other characterizing factors are also considered. Such other factors include whether or not the property is a primary residence, whether the property is occupied by a primary resident or by a renter; the purpose of the loan whether an initial purchase, a cash out refinancing, a term and/or interest rate adjustment refinancing, etc. As can be understood by a person skilled in the art, these and other characterizing factors affect the scoring in any models utilized in the system. Exemplary input parameters (variables) used in CORAL 212 Models and PLATES 211 Models are shown in FIG. 15.

Referring to FIG. 10, a CORAL 212 Model and a PLATES 211 Model building is initiated at steps 1001 and 1004 respectively, by a Model Building Module 218. Both CORAL 212 and PLATES 211 Models utilize linear regression analysis on a set of input parameters. As recited previously, different set of input parameters are used for CORAL 212 and PLATES 211 Models. An exemplary datatable showing representative input variables used in modeling CORAL Model 212 and PLATES Model 211 is shown in FIG. 15.

CORAL Model 212 uses public data fields as input parameters. Examples of public data fields include mortgage loan amount, property type, unemployment rate, occupation wage, etc. For the creation of CORAL Model 212, public data fields of historical mortgage data (Historical Mortgage Data 204), as stored in a Proprietary Mortgage Loan Database 116 are retrieved at step 1003. Because CORAL Model 212 does not require underwritten mortgage data, parameters obtained from underwriting process (for example, pre-categorized type of fraud as explained in FIG. 7) are excluded.

On the other hand, PLATES Model 211 utilizes public data fields, non-public data fields as well as underwritten data, and thus, all such data is retrieved from historical mortgages stored in Proprietary Mortgage Loan Database 116 are retrieved at step 1004. Examples of non-public data include number of previous bankruptcies applicant has been involved with, difference between the property appraisal price and the sales price etc. In addition to non-public data, PLATES Model 211 utilizes parameters obtained from underwriting process as described in FIG. 7.

Next, at step 1007, retrieved historical mortgages and associated outcomes (fraudulent or non-fraudulent) are utilized for creating a modeling data pool, for both CORAL 212 and PLATES 211 Models. As can be understood by a person skilled in the art, creating modeling data pool additionally involves handling missing data/outliers in the data, and necessary data format conversions.

Mortgage loans in modeling data pool are used for developing and testing CORAL 212 and PLATES 211 Models. Thus, at step 1008, modeling data pool is partitioned into a development data pool (for developing a model) and a testing data pool (for testing a developed model). Consequently, each mortgage loan in modeling data pool is assigned to either a development data pool or a testing data pool. At step 1009, a set of input parameters and their corresponding outcomes are selected for every loan in development data pool. As can be understood by one skilled in the art, input parameters are independent variables and their corresponding outcomes are dependent variables, in linear regression analysis.

Next, at step 1010, linear regression analysis is performed on input parameters and their corresponding outcomes to compute statistical weights (coefficients) that reflect statistical significance of input parameters on their corresponding outcomes. These statistical weights are used in combination with the corresponding input parameters to generate (at step 1011) a probability function that predicts probability of fraud (as a non-negative percentage) associated with mortgage loans, for both CORAL Model 212 and PLATES Model 211 respectively.

Validity of both CORAL 212 and PLATES 211 Models are tested by utilizing these models to predict a probability of fraud for mortgage loans in the testing data pool, then mapping this probability to a fraudulent/non-fraudulent outcome, and then comparing with actual (predetermined) outcomes of mortgage loans. As mentioned previously, a testing data pool comprises historical mortgage loans (Historical Mortgage Data 204) having predetermined outcomes stored in a Proprietary Mortgage Loan Database 116.

Still referring to FIG. 10, at step 1012, a set of input parameters are selected from mortgages in testing data pool. As can be understood by a person skilled in the art, input parameters selected from mortgages in testing data pool are identical to a set of input parameters selected from development data pool, but are assigned different values.

At following step 1013, input parameters selected from mortgages in testing data pool are passed to respective CORAL Model 212 and PLATES Model 211, in order to test the validity of these models. Thus, beginning at step 1014, a first mortgage loan in testing data pool is selected, and respective CORAL Model 212 and PLATES Model 211 are executed (at step 1015) on this loan, to arrive at a probability of fraud. Then at step 1016, Model Building Module 218 determines whether probability of fraud exceeds 50% or not. In case probability of fraud exceeds 50%, mortgage loan is marked as fraudulent (at step 1017), otherwise mortgage loan is marked as non-fraudulent (at step 1018). This process of predicting probability of fraud and then mapping probability of fraud to a fraudulent/non-fraudulent outcome is repeated for every mortgage loan in testing data pool, until all loans in testing data pool have been marked as fraudulent/non-fraudulent. Accordingly, at step 1019 Model Building Module 218 verifies whether or not every mortgage loan in testing data pool has been marked as fraudulent/non-fraudulent. In case every mortgage loan in testing data pool has not been marked, a next loan in testing data pool is selected, and the process restarts at step 1015.

After every mortgage loan in testing data pool has been marked as fraudulent/non-fraudulent, Model Building Module 218 assesses whether majority of outcomes (fraudulent/non-fraudulent) predicted by CORAL Model 212 and PLATES Model 211 agree with actual (predetermined from historical mortgages) outcomes or not. According to one embodiment, predicted outcomes and actual outcomes agree at least 90% of the time. However, other values can be chosen, depending on desired accuracy of agreement between predicted outcomes and real outcomes, for example, as indicated in corporate business rules (Client's Business Rules 216) of banks and financial institutions.

In case outcomes predicted by CORAL Model 212 and PLATES Model 211 do not agree with majority of actual outcomes of mortgage loans in testing data pool, Model Building Module 218 restarts the process (at step 1009) of selecting a set of input parameters with their respective outcomes and using linear regression analysis to compute weights. As can be understood by a person skilled in the art, this method of generating a probability of fraud relies on computer implemented simulation techniques that can theoretically generate a different set of statistical weights (coefficients) each time. However, if such a simulation is run sufficiently large number of times, and a (stochastic) time averaged value of weights is calculated, then this time averaged value of weights is a good approximation to the actual statistical weights.

In case (at step 1021) majority of actual outcomes of mortgage loans agree with outcomes predicted by CORAL 212 and PLATES 211 Models, input parameters selected and their corresponding statistical weights are saved in CORAL Database 214 and PLATES Database 213. These models are executed on mortgage loans received from client banks and financial institutions, by a Forecast Modeling Module according to the steps shown in FIG. 9 to arrive at a risk score (probability of fraud) and thereby a result of risk assessment on said mortgage loan.

Turning now to FIG. 11, a flowchart illustrating computer-implemented steps performed by a Front End Export Results Module 125 are shown, involving appropriate data displays and prompts for an individual (client) working at a bank or financial institution and authorized to interact and export result of the risk assessment performed by MFDS. An exemplary screenshot of Front End Export Results Interface 215 through which a client interacts with Front End Export Results Module 125 is shown in FIG. 18.

Starting at step 1101, Front End Export Results Module 125 authenticates client (an individual working at a bank or financial institution) credentials received through Front End Export Results Interface 215 at step 1101. Since a client can be authorized to view certain types of financial instruments (for example, single loan applications), the system verifies the authorization of client at step 1102. If a client is authorized to review MFDS processing results related to a loan portfolio, then the system waits for a client to choose a portfolio at step 1102.

In case a client is authorized to review MFDS processing results related to a loan portfolio, at step 1106 the system waits for a client to choose a portfolio (for example, by clicking “Choose portfolio” menu 1803 in Front End Export Results Interface 215). After a client has chosen a portfolio, the system receives a request from client containing a selected portfolio, at step 1107. Then, at step 1108 Front End Export Results Module 125 retrieves results of MFDS processing in connection with selected loan portfolio from MFDS Database 126, and displays (at step 1109) a summary of results (as shown in region 1804 in FIG. 18) to the client. After displaying summary of results of MFDS processing to the client, the system waits for further entry from the client at step 1110 in relation to viewing additional details of results of MFDS processing, and/or export additional details of results of MFDS processing. After the client has entered a choice through Front End Export Results Interface 215, Front End Export Results Module 125 determines choice entered by client. Thus, at steps 1111 the system determines whether the client chooses to view additional results (indicated by client clicking on button 1805) or not. As can be seen from region 1805 in FIG. 18, additional details comprise results of validation of different attributes in mortgage loan related to applicant or subject property, e.g., validation of applicant's Social Security Number, validation of value of subject property, etc.

If the system determines at step 1111 that the client wishes to view additional results, then details of results are displayed to client at step 1112, after which the system reverts back to step 1110 and waits for the client's entry. In case the system determines at step 1111 that the client wishes to export results of MFDS processing (indicated by client clicking on button 1811), the system transfers (at step 1114) details of results of MFDS processing to a local folder in the client's computer and finally Front End Export Results Module 125 exits current process.

In case the system verifies at step 1102 that the client is not authorized to review MFDS processing results related to a loan portfolio, the system retrieves result of MFDS processing in connection with a single mortgage loan (at step 1103) from MFDS Database 126. At step 1104, Front End Export Results Module 125 displays results (along with additional details) of MFDS processing to a client. Then at step 1105, the system waits for the client's entry to export details of results of MFDS processing in connection with single mortgage loan. After the client enters option to export details of results of MFDS processing, the system transfers details of results of MFDS processing to client (at step 1114) and finally Front End Export Results Module 125 exits current process. As can be understood, this method of displaying (and exporting, if necessary) the results of MFDS processing to an individual working at a client bank or financial institution applies to any type of financial instruments and is not limited to single mortgage loans or loan portfolios.

FIG. 12 is a flowchart illustrating steps taken an individual working at a bank or financial institution who is authorized to interact and export result of the risk assessment performed by MFDS, using Front End Results Interface 215 (as shown with an exemplary screenshot in FIG. 18). Starting at step 1201, a client (an individual working at a bank or financial institution) logs on to Front End Results Interface 215 using a client's credentials. As can be understood, a client is a loan officer 104 or a portfolio manager 113 working at a bank or a financial institution. Although this flowchart indicates steps performed in reviewing a loan portfolio, it can be understood that similar steps are performed in reviewing any type of financial instrument, and not limited to mortgage portfolios.

At step 1204, the client chooses a mortgage loan portfolio (by clicking “Choose portfolio” menu 1803 in Front End Export Results Interface 215). After the client has chosen a mortgage loan portfolio, Front End Export Results Module 125 retrieves results of MFDS processing in connection with selected loan portfolio, from MFDS Database 126, and displays a summary of results to client (in region 1804 in FIG. 18).

Client reviews summary of results at step 1205, and then decides (at step 1206) whether or not to review additional details of results of MFDS processing. In case client chooses to review additional details, client enters a choice (not shown here) through Front End Results Interface 215. Accordingly, Front End Export Results Module 125 displays additional details of results of MFDS processing to client, which client reviews at step 1207, and the system, in turn, waits for further entry from client. As can be seen from region 1805 in FIG. 18, additional details of results of MFDS processing comprise results of validation of different attributes in mortgage loan related to applicant or subject property, e.g., validation of applicant's Social Security Number, validation of price of subject property, etc.

In case the client does not choose to review additional details of results of MFDS processing, or after client has reviewed additional details, client has an option to export such details (at step 1208) to a local folder in client's computer. Thus, if a client clicks on “Export” button 1811 (shown in FIG. 18), a menu is displayed that requests the client to select a destination (local) folder in the client's computer to export results to. Accordingly, Front End Export Results Module 123 transfers (at step 1209) details of results of MFDS processing to client's computer, and then exits from current process. As can be understood and appreciated, result of the risk assessment performed by MFDS can be displayed in different ways to an individual working at a client bank or financial institution, and is not limited to the method as discussed in FIG. 12.

Turning now to FIG. 13, an exemplary database schema 1300 illustrating principal tables and data columns storing representative data in MFDS Database 126 is shown. As can be seen, MFDS Database 126 stores a plurality of information received from a single mortgage application 102 or a bundle of mortgage loans in a loan portfolio 110 in a storage disk drive in the form of data tables, each table further comprising data columns (fields). As can be seen, MFDS Database 126 comprise exemplary Applicant Table 1302, Loan Table 1303, Property Table 1304, and Attachment Table 1305, each table further comprising various fields as shown.

Applicant Table 1302 comprises unique fields that identify an applicant. As shown, Applicant Table 1302 comprises an ApplicantID field that stores an unique ID representing an applicant, FIRST_NAME, LAST_NAME fields each storing a character string representing first name and last name of an applicant, and a SSN field that stores the Social Security Number of an applicant. For example, an applicant John Doe having a Social Security Number 111-22-3333 is stored in Applicant Table 1302 with an ApplicantID “1”, the characters “John” being stored in a FIRST_NAME field, and the characters “Doe” being stored in a LAST_NAME field, and 111-22-3333 being stored in a SSN field.

As can be seen from FIG. 13, Applicant Table 1302 is related to Loan Table 1303 by ApplicantID field. As can be understood by a person skilled in the art, storing data in the manner described above is a typical feature of relational databases, in which data is divided into various groups (tables) comprising several fields, and different groups are related to each other by one or more fields.

Loan table 1303 contains mortgage loan related information and comprises fields named as LoanID, ClientID, LoanNumber, ApplicantID, PropertyID, and LoanAmount. A LoanID field in Loan Table 1303 is a unique number identifying a loan, for the purposes of MFDS processing. A ClientID field is used to identify uniquely a client (bank or financial institution) and is further associated with a LoanNumber field, an ApplicantID field, a PropertyID field, and a LoanAmount field. A mortgage loan is identified by a LoanNumber field by a client bank or financial institution, a mortgage loan applicant is identified by ApplicantID field, a property identifying number (for a particular client) is indicated by a PropertyID field, and a mortgage loan amount is indicated in a LoanAmount field. For example, ApplicantID “1” (identified in ApplicantTable 1302 as John Doe) in connection with a mortgage loan associated with a LoanNumber 123456789 for a property identified as PropertyID “1”, said mortgage loan being associated with an originating bank/financial institution identified as ClientID “2”, said mortgage having a LoanAmount $117,900.

Property Table 1304 contains data related to real estate properties whose information is stored in MFDS Database 126. It further comprises a PropertyID field, a StreetAddress field indicating street address of location of property, and a City field which indicates a city where the subject property is located. For example, it can be seen that a property identified as PropertyID “1” (associated with a mortgage loan identified by LoanNumber 123456789 in LoanTable 1303) is located at StreetAddress “1 Main Street” in a City “Dallas”. It can be further seen that PropertyID is a common field between Loan Table 1303 and Property Table 1304.

As shown in FIG. 13, an Attachment Table 1305 is related to a Loan Table 1303 by LoanID and ApplicantID, which are common fields to both tables. As can be seen, Attachment Table 1305 comprises an AttachmentID field, a LoanID field, an ApplicantID field and a Path field. LoanID field, as recited previously, is used to identify a mortgage loan for MFDS processing. Further as mentioned earlier, ApplicantID field uniquely identifies an applicant for a mortgage loan. AttachmentID field is used to identify an attachment associated with a mortgage loan, the attachment being stored on a storage disk at a location as indicated in the Path field. As recited previously, an attachment is linked to a mortgage loan and contains electronically scanned information obtained from banks and financial institutions in connection with a mortgage loan. Moreover, such information can be used as specific evidence to indicate that a mortgage loan is fraudulent. The process of linking such attachments to a mortgage loan are performed by a human underwriter and described in detail in FIG. 7 and FIG. 8.

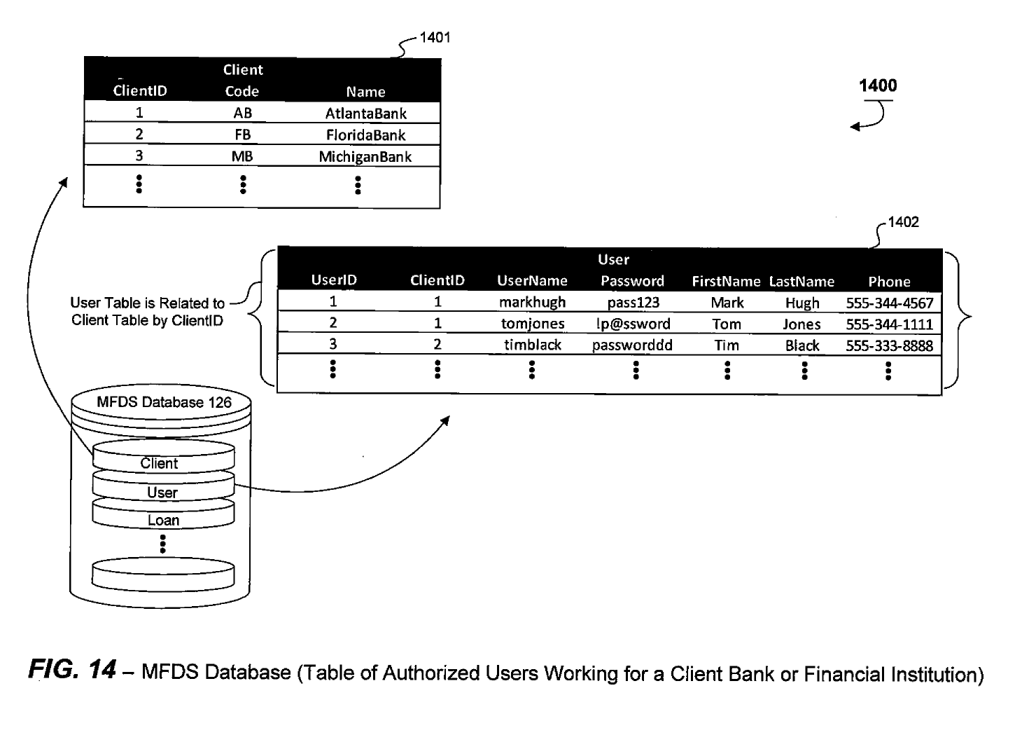

FIG. 14 is an exemplary database schema 1400 showing tables and constituent fields in MFDS Database for storing information pertaining to authorized users (individuals authorized to access the results of risk assessment performed by MFDS) working at clients (banks or financial institutions). As can be seen, MFDS Database 126 comprises exemplary Client Table 1401 and User Table 1402. Client Table 1401 further comprises a ClientID field, a Client Code field and a Name field. ClientID field identifies a client (bank or financial institution) associated with a short character string indicated in a Client Code field. A Name field stores an abbreviated name of a client. For example, it can be seen from ClientTable 1401 that a ClientID “1” is associated with a ClientCode “AB” abbreviating an arbitrary bank called “Atlanta Bank”. It can be seen that ClientID is related to Loan Table 1303 (FIG. 13) and User Table 1402 (FIG. 14).

User Table 1402 stores details of individuals working for a client bank or financial institution, who are authorized to access the results of risk assessment performed by MFDS on respective mortgage loan(s). User Table 1402 comprises UserID field, ClientID field, UserName field, User Password field, FirstName field, LastName field, and a Phone field. UserID field is a unique number identifying an authorized user (individual) who accesses the MFDS, working for a bank or financial institution indicated in a ClientID field, having a username and password as indicated in UserName and UserPassword fields respectively. Further, first name, last name, and phone numbers of such an user is indicated in FirstName, LastName and Phone fields respectively. For example, Table 1402 reveals that an user with UserID “1” is associated with a bank identified by ClientID “1”, having a UserName “markhugh”, Password “pass 123”, a FirstName “Mark”, a LastName “Hugh”, and a Phone “555-344-4567”.

Although not shown in FIGS. 13, 14 databases (as shown in FIG. 2) of MFDS 119 communicate with master MFDS Database 126 to update each other's records in MFDS Database 126 in order to provide up-to-date information to various software modules as necessary. According to one embodiment, an updation of records can be triggered by a change in information that is common to MFDS Database 126 and other database(s). According to another embodiment, such updation of records can happen at periodic intervals of time (every hour, minute, second, etc).

FIG. 15 is an exemplary database schema 1500 showing tables storing representative variables used in connection with CORAL 212 and PLATES 211 Models. CORAL Database 214 stores an exemplary CORAL Variables Table 1501 that comprises LoanID field, a LoanAmount field, a PropertyType field, and a YearOfMortgageOrigination field. LoanID field is used to identify a mortgage loan for MFDS processing. LoanAmount field indicates mortgage loan amount associated with a mortgage loan specified in LoanID field. PropertyType field indicates type of property associated with a mortgage loan. In other words, PropertyType field indicates whether mortgage loan specified in LoanID field is a mortgage for a condominium, a mortgage for a primary residence, a mortgage for a vacation (second) home, a mortgage on an investment property, a mortgage on a combined residential and business property, a refinancing of any of these, etc. YearOfMortgageOrigination field indicates a calendar year when mortgage loan specified in LoanID field is applied for.

A PLATES Database 213 stores a PLATES Variables Table 1502 used in connection with a PLATES Model 211. As recited previously, CORAL Models 212 utilize public data fields only, whereas PLATES Models 211 utilize public data fields, non-public data fields and parameters obtained from mortgage underwriting process (as explained in FIG. 7). In addition to fields listed in CORAL Variables Table 1501, PLATES Variable Table 1502 comprises a SSNMatch field, a LoansPriorCurrentApplication field, and a NumberofBankruptcyRegistered field. SSNMatch field indicates whether there is a match or not between Social Security Number provided by applicant in applicant's mortgage application and Social Security Number in applicant's public records as available from a Third Party Information Source 128. LoansPriorCurrentApplication field in PLATES Variables Table 1502 specifies number of previous mortgage loans applied for, by an applicant associated with a mortgage loan specified in LoanID field, described previously. Further, NumberofBankruptcyRegistered field indicates number of bankruptcies filed previously by an applicant. For example, it can be seen from PLATES Variables Table 1502 that a mortgage loan indicated by LoanID “1” is associated with a mortgage loan amount “$117,900” for a PropertyType “1” having a YearOfMortgageOrigination “2005”, applicant's SSNMatch verification status “1”, LoansPriorCurrentApplication indicated as “2”, and NumberofBankruptcyRegistered indicated as “0”. As can be understood and appreciated, variables shown in datatables in FIG. 15 are for illustration purposes. Various other variables can be stored and in various other formats (hexadecimal, character string, binary, alphanumeric etc).

FIG. 16 illustrates an exemplary screenshot of a graphical user interface (GUI) (mentioned herein as Import Data Interface 217) as seen by an internal analyst who uses this interface to interact with Mortgage Data Processing Module 122, and inspect results of the normalization process performed by Mortgage Data Processing Module 122. Details of the steps performed by an internal analyst are shown with the help of a flowchart in FIG. 5, and steps involved in the normalization process performed by Mortgage Data Processing Module 122 are shown in FIG. 4. As mentioned previously, normalization of mortgage loan data received from banks and financial institutions results in conversion and consolidation of disparate information received from a variety of sources (and in different file formats) into a common standard for utilizing such information. Normalization process also causes the data to be amenable for query and further processing by one or more Third Party Information Sources 128 like credit bureau agencies, bankruptcy courts, government agencies such as the FDIC, LexisNexis etc. As shown, menu bar 1601 provides various functionalities (for example, “Manage profile”, “Import Data”, etc.) associated with this interface. “Import Data” is shown underlined indicating that a current screen provides functionalities for importing mortgage loan data received from client (bank or financial institution) into appropriate tables and column in MFDS Database 126.

“Choose Client” menu 1602 when clicked, displays a list of clients whose mortgage loan data are stored in MFDS Database 126. After choosing a client using menu 1602, analyst chooses a proprietary template using “Choose Proprietary Template” menu 1603. As mentioned previously, a proprietary template is a document containing details of normalization process—mapping information between columns in mortgage data file provided by banks and financial institutions, to the appropriate columns in MFDS Database 126. As recited previously, a client bank or financial institution can have multiple proprietary templates.

Next, the analyst chooses a mortgage loan file related to a respective client using “Choose Mortgage File” menu 1604. After the analyst has chosen a mortgage file, the name of this file is displayed in “Mortgage File” region 1605. Next, the analyst clicks “Start import” button 1606 to invoke the import process. This results in Mortgage Data Processing Module 122 first verifying that analyst has selected information (a client, a proprietary template document and a mortgage file) required to perform normalization. After the system verifies that the required information has been successfully received, then the system performs the normalization process of mapping columns in client provided mortgage data file to corresponding columns in MFDS Database 126, according to instructions provided in a proprietary template document.

If normalization is successfully performed, result of normalization is displayed to analyst in region 1607 for analyst's inspection and review. As shown in FIG. 16, region 1607 further comprises “Mortgage File Column Name” (region 1617), “MFDS Column Name” (region 1608) and “MFDS Table Name” (region 1609). “Mortgage File Column Name” (region 1617) indicate the columns (for example, MortgageID, Mort_Amount, etc.) provided in mortgage file received from bank or financial institution. “MFDS Column Name” (region 1608) indicates columns in MFDS Database 126 into which the columns from client-provided mortgage file are mapped. For example, it can be seen from FIG. 16 that “MortgageID” in client provided mortgage data file is mapped into “LoanNumber” in MFDS Database 126 as an outcome of an exemplary normalization.

Further, “MFDS Table Name” (region 1609) indicates a name of a column in MFDS Database 126 where a respective column (from “MFDS Column Name”) is stored. For example, it can be seen that “LoanNumber” is stored in a “Loan” table (Loan Table 1303 in FIG. 13) in MFDS Database 126. Although not shown here, it can be understood that if normalization is not successful, then a normalization mismatch is reported by Mortgage Data Processing Module 122.

After the analyst has inspected visually that normalization is successful, the analyst clicks on “Validate” button 1614 to start the datatype validation process. During datatype validation process, the system checks whether every data entry in every column of the client provided mortgage data file has the identical datatype. In FIG. 16, for example, Mortgage Data Processing Module 122 checks whether every data entry in column named “Mort_Amount” are integers or not. In another example, Mortgage Data Processing Module 122 checks whether every data entry in column named “F_NAME” is a string of characters or not. If datatype validation is successful, Mortgage Data Processing Module 122 waits for analyst to click “Finish import” button 1615. After the analyst clicks “Finish import” button 1615 data from client provided mortgage file is copied into the corresponding columns in MFDS Database 126. Although not shown in FIG. 16, it can be understood that if datatype validation is unsuccessful, an error message is displayed to analyst.

Now referring to FIG. 17, an exemplary screenshot of an Underwriting Information Interface 206 is shown, as seen by an internal analyst (underwriter) who performs review and inspection (according to the steps shown in FIG. 8.) of an underwriting process performed by an Expert Underwriting Module 123. Expert Underwriting Module 123 further allows interaction by providing appropriate data displays/prompts (according to the steps shown in FIG. 7) for the underwriter to review, analyze and enter information through Underwriting Information Interface 206.

As shown in FIG. 17, menu bar 1701 displays various functionalities available to underwriter through the interface. For example, underwriters can select “MANAGE PROFILE” to manage their user profiles saved in MFDS 119, or underwriters can select “LOG OUT” to log out of the interface. An underwriter who wishes to review a mortgage loan first chooses a loan (from a list of available loans stored in MFDS Database 126) using “Choose loan” menu 1702. Next, the mortgage loan information is displayed in region 1703. As seen in FIG. 17, a loan identified by a loan number “11110000” for an applicant with last name “Doe” residing in “3 Main Street” is displayed. Unique details (first name, last name, date of birth, Social Security Number) that identify applicant are shown in region 1704 named “Applicant”. For example, region 1704 displays a “First Name” John, a “Last Name” Doe, a “Date of Birth” Mar. 12, 1978, and a “SSN” 123456789.

Applicant's address is displayed in region 1705 named “Applicant's Address”. For example, information in region 1705 displays a “House Number” 3, a “Street Name” Main Street, a “City” Dallas, a “State” CA, and a “Zip” 12345. As can be understood and appreciated, information pertaining to the applicant (for example, applicant's name and address) are provided by banks and financial institutions (Applicant History Data 201 as shown in FIG. 2). This information is received by Mortgage Data Processing Module 122, normalized and processed (as shown in FIG. 4) and stored in MFDS Database 126. During the underwriting process, this information is displayed to an underwriter through an Underwriting Information Interface 206.

In region 1716, “Third Party Information”, i.e. data obtained from Third Party Information Sources 128 is displayed. As can be seen in FIG. 17, for example, applicant's Social Security Number as available in applicant's public records from Third Party Information Sources 128 is indicated as 888456789. Further, region 1716 also displays a “State” TX and a “Zip” 34567. As can be understood, various information from Third Party Information Sources 128 (other than applicant's Social Security Number and address-related information) are also displayed in region 1716.

Thus, Expert Underwriting Module 123 detects a discrepancy (according to the steps discussed in FIG. 7) between Social Security Number provided by bank (displayed as “SSN” record in region 1704, that in turn was provided by applicant in applicant's mortgage application) and Social Security Number in applicant's public records as available from a Third Party Information Source 128. Furthermore, Expert Underwriting Module 123 detects discrepancies in applicant's state and zip code by comparing applicant's information provided by bank and applicant's information as obtained from Third Party Information Sources 128. As a result, these discrepancies are displayed in region 1707 for underwriter's review. As recited previously, Expert Underwriting Module 123 detects discrepancy by comparing information stated in normalized mortgage data, data received from Third Party Information Source 128, and information in corporate business rules (Client's Business Rules 216) as explained earlier.

After detecting a discrepancy, Expert Underwriting Module 123 further classifies discrepancy (for example, discrepancy in applicant's Social Security Number) to a pre-categorized type of discrepancy (“SSN Misrepresentation”) listed in a Fraud Classification Table 220 (FIG. 2). Fraud Classification Table 220 is a table in Decisioning Database 205 that lists a plurality of fraud types relevant to mortgage loans. Typical fraud types include appraisal, compliance, liability, mis-representation, occupancy, and other such fraud types.

In addition to classifying a discrepancy to a pre-categorized fraud type (for example, “SSN Misrepresentation”), Expert Underwriting Module 123 also displays a pre-determined supporting reason (“Provided SSN is not valid”) associated with discrepancy in “Supporting Reason” region 1709. As can be seen from FIG. 17, an underwriter can also edit a pre-existing discrepancy (change reported fraud type to select a different pre-categorized fraud type) by clicking on “Edit” button 1710, and further edit supporting reason for discrepancy as well. Further, underwriter can also delete a discrepancy (“Delete” button 1711) which results in deletion of the discrepancy from Decisioning Database 205.

“Attachments” region 1718 displays various buttons available to an underwriter to add/view/delete specific evidence to indicate fraud, linked to a discrepancy in the form of an attachment. If an underwriter chooses to add (link) an attachment to a discrepancy (by clicking on “Add” button 1713), then a menu is displayed (not shown in FIG. 17) to an underwriter asking underwriter to select an attachment (from a location on underwriter's computer or from MFDS Database 126) to link to a discrepancy. Further, underwriter can view an attachment linked to a discrepancy by clicking on “View” button 1714 or delete an attachment linked to a discrepancy by clicking on “Delete” button 1715.

An underwriter also has an option of adding a discrepancy by clicking on “Add Discrepancy” button 1706 on Underwriting Information Interface 206. As can be understood, underwriter interacts with Expert Underwriting Module 123 using Underwriting Information Interface 206. Actions taken by an underwriter (for example, clicking various buttons) in connection with inspecting an underwriting process are tracked by Expert Underwriting Module 123, and eventually changes (if any) made by underwriter to discrepancies are saved in Decisioning Database 205, after underwriter clicks on “Submit” button 1712. Expert Underwriting Module 123 then converts discrepancies into numerical parameters for use by Forecast Modeling Module 124 for forecasting risk associated with a mortgage.

FIG. 18 is an exemplary screenshot of a Front End Results Interface 215, as viewed by a client (an individual, for example loan officers 104 or portfolio managers 113 working at a bank or financial institution) who is authorized to interact with Front End Export Results Module 125 and export results of the risk assessment performed by MFDS. Details of steps performed by Front End Export Results Module 125 are explained in FIG. 11, and steps performed by an individual in interacting with Front End Export Results Module 125 for reviewing results of MFDS processing are explained in FIG. 12.

As seen from FIG. 18, menu bar 1801 displays various functionalities available to a client through a Front End Results Interface 215. For example, a client can choose to manage client's profile (for example, managing username/password) stored in the system by clicking on “MANAGE PROFILE”, view attachments or documents associated with a mortgage loan, stored in MFDS Database 126, log out of interface by clicking on “LOG OUT”, etc. A “RESULT” option in menu bar 1801 is highlighted indicating that the interface is displaying results of MFDS processing on a mortgage loan. A single mortgage loan associated with a client can be searched in MFDS Database 126 using a “Loan Search” (box 1802). Further, a mortgage loan portfolio that has been processed by MFDS is selected by a client (associated with said mortgage loan portfolio) using a “Choose portfolio” menu 1803, and the display process begins.

After a client selects a mortgage loan portfolio, Front End Export Results Module 125 retrieves results of MFDS processing from MFDS Database 126, and displays a summary of results of MFDS processing in region 1804. As can be seen from FIG. 18, region 1804 comprises several columns: “Portfolio ID”, “Loan Number”, “Applicant”, “Overall Risk Level (CORAL)”, “Overall Risk Level (PLATES)”, and “Details”.

“Portfolio ID” uniquely identifies a mortgage loan portfolio associated with a client. As can be understood, several mortgage loan portfolios associated with a client can be processed by MFDS, and a mortgage loan portfolio further comprises several single mortgage loans. Region 1804 indicates that results of MFDS processing on mortgage loans bundled in a mortgage loan portfolio having a “Portfolio ID” as one (1) are being displayed. “Loan Number” column specifies a loan number uniquely identifying a mortgage loan that is bundled in a mortgage loan portfolio. In FIG. 18, it can be seen that mortgage loans identified by loan numbers “1234567”, “34567”, “1237890” are bundled in a mortgage loan portfolio having a “Portfolio ID” as one (1). “Applicant” column contains name of applicant applying for a mortgage loan identified by a loan number. For example, it can be seen that an applicant named “John Doe” has applied for a mortgage loan identified by a loan number “1234567”, and an applicant named “Tim Orange” has applied for a mortgage loan identified by a loan number “1237890”.

Risk scores (probability of fraud) predicted by a CORAL Model 212 and PLATES Model 211 are obtained by executing such models on a mortgage loan. Subsequently, threshold values (received from a client in the form of Client's Business Rules 216) are used to classify risk scores into various predetermined risk levels by Forecast Modeling Module as indicated in FIG. 9. For example, a mortgage loan having a loan number “1237890” has a severe risk level as predicted by both CORAL Model 212 and PLATES Model 211, and indicated in “Overall Risk Level (CORAL)” and “Overall Risk Level (PLATES)” columns in region 1804. Although not shown here, it can be understood that probability of fraud predicted by CORAL Model 212 and PLATES Model 211 can be different, and further classification of a mortgage loan into a predetermined fraud level can be different. In such a case, additional review and investigation (involving underwriting) is performed. The basis of such a review depends on the probability of fraud predicted by CORAL Model 212 and PLATES Model 211 as well as the mortgage loan amount involved.

Region 1804 displays overall risk (representing a combined effect of all types of fraud) associated with a mortgage loan in columns indicated as “Overall Risk Level (CORAL)” and “Overall Risk Level (PLATES)”. As recited previously, CORAL Model 212 and PLATES Model 211 can also be used to determine a probability of fraud associated with a specific type of pre-categorized fraud (mis-representation, appraisal, etc listed in a Fraud Classification Table 220), and further this probability of fraud can be classified into a predetermined a risk level.

Referring to FIG. 18, if a client wishes to view additional details (for example, related to validation of subject property, applicant's Social Security Number, etc.) of MFDS processing then client clicks on “Details” button 1805 and then Front End Export Results Module 125 displays additional details through Front End Results Interface 215. For example, regions 1806 and 1807 display the result of validation of applicant's Social Security Number and property respectively. In other words, regions 1806 and 1807 report whether or not any kind of issues (mismatch, discrepancies, errors etc.) were detected in validation of applicant's Social Security Number and property respectively.

It can further be seen from FIG. 18, if client clicks on “Details” button for a loan number “1237890” (that is shown highlighted in the figure) then results of classification of CORAL Model 212 and PLATES Model 211 for specific fraud type, are shown in regions 1808, 1809 respectively. As can be seen from regions 1808, 1809 both models predict that there is a severe risk of appraisal and mis-representation fraud associated with mortgage loan number “1237890”. Although not shown here, it can be understood that for a specific type of fraud, CORAL Model 212 and PLATES Model 211 can classify a mortgage loan into different risk levels.

An “Export” button 1811 is used to export details of results of MFDS processing from MFDS Database 126 to a local folder in a client's computer. As can be understood by a person skilled in the art, if a client clicks on “Export” button 1811, a menu is displayed that requests client to select a destination (local) folder in client's computer to export results to. Although not shown here, it is understood that several other details of MFDS processing can be displayed on Front End Results Interface 215.

From the foregoing, it will be understood and appreciated that there has been described a system and associated processes and methods for processing loan information from various sources including third party data sources associated with individuals involved in mortgages and borrowing, and determining the particular reasons for particular loans being problematic or fraudulent, characterizing mortgages in a collection of prior mortgages by indicating information relating to the reasons for such particular loans being fraudulent or otherwise “bad”, and providing a tool for use by customers such as banks and other financial institutions to processing existing portfolios of loans as well as new mortgage loan applications, for purposes of assessing and minimizing risks associating with various mortgage loans and portfolios of such loans, and consequently taking relevant actions as deemed necessary.

It will be understood that aspects of the disclosure are implemented as computer program processes and/or modules and/or programs that execute on general purpose computers operated by an operator of the system 100. FIG. 1 illustrates an example of a suitable networked computing system environment on which embodiments may be implemented. The networked computing system environment is only one example of a suitable computing environment and is not intended to suggest any limitation as to the scope of use or functionality of the claimed subject matter. Neither should the computing environment be interpreted as having any dependency or requirement relating to any one or combination of components illustrated in the exemplary operating environment.

Although aspects of the disclosure are shown as computer-implemented processes, occurring in a particular order or sequence, and on occasion with seemingly sequential numbering or identification in the drawings, it should be understood that in many instances there is no required ordering or sequencing of certain processes or steps or operations, except when certain processes or steps or operations require the results of a temporally-earlier process or step or operation in order for its function to occur. Many computer operations are asynchronous in nature, many operate in endless loops awaiting a particular input or stimulus, and many operate in response to receiving a message or being passed a parameter or provided with an input or stimulus. Thus, no ordering or sequencing should be imposed on the claimed disclosure except where necessary and required due to the need for a prior temporal operation. Generally, therefore, the present disclosure and its aspects should be interpreted as not limited to a particular ordering or sequence.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like. Embodiments may be described in the general context of computer-executable instructions, such as program modules, being executed by a computer. Generally, program modules include routines, programs, objects, components, data structures, etc. that perform particular tasks or implement particular abstract data types. Embodiments as described herein are designed to be practiced in distributed computing environments where tasks are performed by remote processing devices that are linked through a communications network. In a distributed computing environment, program modules are located in both local and remote computer storage media including memory storage devices.

An exemplary system for implementing some embodiments includes a general-purpose computing device in the form of one or more computers or servers. Components of such computers or servers may include, but are not limited to, a processing unit, a system memory, and a system bus that couples various system components including the system memory to the processing unit. The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computers and servers typically include and utilize a variety of computer readable media. Computer readable media can be any available media that can be accessed by the computer or server and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory for a computer or server includes computer storage media in the form of volatile and/or nonvolatile memory such as read only memory (ROM) and random access memory (RAM). A basic input/output system (BIOS), containing the basic routines that help to transfer information between elements within computer or server, such as during start-up, is typically stored in ROM. RAM typically contains data and/or program modules that are immediately accessible to and/or presently being operated on by a processing unit in the computer or server. By way of example, and not limitation, a computer utilized in constructing the system 100 includes an operating system, application programs, other program modules, and program data.

The computer or server may also include other removable/non-removable volatile/nonvolatile computer storage media. By way of example only, each computer or server may include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. A hard disk drive is typically connected to the system bus through a non-removable memory interface, and any magnetic disk drive and/or optical disk drive are typically connected to the system bus by a removable memory interface.

The drives and their associated computer storage media discussed above provide storage of computer readable instructions, data structures, program modules and other data for the computer or server. As is known to those skilled in the art, a hard disk drive typically stores an operating system, application programs, other program modules, and program data.

A user such as an end user may enter commands and information into his or her computer through input devices such as a keyboard, a microphone, and/or a pointing device such as a mouse, trackball, touch sensitive screen, or touch pad (not shown). Other input devices may include a joystick, game pad, satellite dish, scanner, or the like. These and other input devices are often connected to the processing unit of the computer through a user input interface that is coupled to the system bus, but may be connected by other interface and bus structures, such as a parallel port, game port or a universal serial bus (USB). A monitor or other type of display device (not shown) is also connected to the system bus via an interface, such as a video interface. In addition to the monitor, computers may also include other peripheral output devices such as scanners, speakers and printer, which may be connected through an output peripheral interface.

With reference back to FIG. 1, computers shown in the system 100 are typically operated in a networked environment using logical connections to other remotely located computers or mobile devices associated with loan officers 104 and/or portfolio managers 113 and/or analysts 160. Any remote computer or other device may be a personal computer, a hand-held device, smartphone, a server, a router, a network PC, a peer device or other common network node, and typically includes many or all of the elements described above relative to the computer. The logical connections depicted in FIG. 1 include the network 150, which can include a local area network (LAN) and/or a wide area network (WAN), but may also include other networks. Such networking environments are commonplace in offices, enterprise-wide computer networks, intranets and the Internet.

When used in a LAN networking environment, a computer or server that executes the MFDS software 120 is connected to the LAN through a network interface or adapter. When used in a WAN networking environment, the computer typically includes a modem or network (e.g. Ethernet) adapter or other means for establishing communications over the WAN, such as the Internet. The modem or network adapter, which may be internal or external, may be connected to the system bus via the user input interface, or other appropriate mechanism. In a networked environment, program modules depicted relative to the computer, or portions thereof, may be stored in the remote memory storage device. It will be appreciated that the network connections shown are exemplary and other means of establishing a communications link between the computers may be used.

The foregoing description of the exemplary embodiments has been presented only for the purposes of illustration and description and is not intended to be exhaustive or to limit the present disclosure to the precise forms disclosed. Many modifications and variations are possible in light of the above teaching.

The embodiments were chosen and described in order to explain the principles of the present disclosure and their practical application so as to enable others skilled in the art to utilize the present disclosure and various embodiments and with various modifications as are suited to the particular use contemplated. Alternative embodiments will become apparent to those skilled in the art to which the present disclosure pertain without departing from their spirit and scope. Accordingly, the scope of the present disclosure is defined by the appended claims rather than the foregoing description and the exemplary embodiments described therein.

What is claimed is:

1. A computer-implemented financial instrument risk assessment system for determining and reporting risk associated with a financial instrument to a client, comprising:
a computer memory; and
a processor coupled to the computer memory and operative to implement:
financial instrument data processing logic, the financial instrument data processing logic operative to (a) receive financial instrument data comprising digitized image files and financial instrument origination data corresponding to an input financial instrument, (b) normalize the financial instrument data, and (c) store normalized financial instrument data corresponding to the input financial instrument in the computer memory for use by other logic;
expert underwriting logic, the expert underwriting logic operative to (a) provide a user interface to a financial instrument analyst for inspection of the normalized financial instrument data stored in the computer memory, (b) access third party information sources to obtain supplemental data for use in connection with determining a risk of the financial instrument, (c) automatically determine the existence of a discrepancy between data in the normalized financial instrument data and any supplemental information obtained from a third party information source, (d) automatically assign a predetermined fraud type to any determined discrepancy, and (e) store information corresponding to the financial instrument data, any determined discrepancies, and any assigned predetermined fraud types in the computer memory as underwritten financial instrument data;
forecast modeling logic for assigning a risk assessment score to the input financial instrument as represented by the normalized financial instrument data and the underwritten financial instrument data, the forecast modeling logic based upon a historical collection of financial instrument data, the historical collection of financial instrument data comprising data corresponding to a plurality of prior financial instruments that (i) are of a type similar to that of the input financial instrument and (ii) have been predetermined to possess at least one of the predetermined fraud types, the forecast modeling logic being operative to store the risk assessment score in the computer memory in association with data corresponding to the input financial instrument; and
export results logic for providing the risk assessment score corresponding to the input financial instrument stored in the computer memory to the client via a client user interface.

2. The system of claim 1, wherein the financial instrument is a mortgage loan.

3. The system of claim 1, wherein the financial instrument is a portfolio of mortgage loans.

4. The system of claim 1, wherein the financial instrument origination data comprises data related to the origination of the financial instrument that includes but is not limited to amount, date of transaction, location and type of collateral, and/or entity associated with the financial instrument.

5. The system of claim 1, wherein the financial instrument data processing logic is also operative to receive financial instrument entity data that includes but is not limited to name, date of birth, address, social security number, previous mortgages, payment history, interest rate, and/or payments made on previous mortgages.

6. The system of claim 1, wherein the financial instrument data processing logic is further operative to process the digitized image files to extract data with optical character recognition (OCR) and store extracted data in the computer memory for use in connection with normalizing.

7. The system of claim 1, wherein a set of client business rules is provided for each one of a plurality of clients that utilize the system, each set of client business rules corresponding to specific policies of qualifying mortgage loan data for a particular client.

8. The system of claim 1, wherein the operation of normalizing the financial instrument data by the financial instrument data processing logic comprises a mapping of data items in received financial instrument data to corresponding data items in database that stores normalized financial instrument data for a plurality of similar financial instruments, the database comprising a part of the computer memory.

9. The system of claim 8, wherein the database of normalized financial instrument data comprises a mortgage fraud detection system (MFDS) database.

10. The system of claim 8, further comprising a proprietary template containing information for mapping information between data items (column) in financial instrument data provided by a particular client of the system to corresponding data items in the database, and wherein the financial instrument data processing logic is further operative to utilize the proprietary template of the particular client in the normalization operation.

11. The system of claim 1, wherein the third party information sources are selected from the group comprising: credit bureau agencies, bankruptcy courts, government agencies, commercial information databases (e.g. Lexis/Nexis), mortgage electronic registration system (MERS).

12. The system of claim 1, wherein a discrepancy between data in the normalized financial instrument data and any supplemental information obtained from a third party information source comprises an indication of a difference between a data item contained in the information provided in the normalized financial instrument data and a corresponding data item obtained from a third party information source, where the information between the two data items is expected to be identical.

13. The system of claim 1, wherein the predetermined fraud types are selected from the group comprising: appraisal fraud, compliance fraud, liabilities fraud, misrepresentation fraud, occupancy fraud.

14. The system of claim 1, wherein the expert underwriting logic is further operative to:
display information relating to any determined discrepancy and any automatically assigned predetermined fraud type to an analyst via the analyst user interface;
receive input from the analyst corresponding to the determined discrepancy; and
store any received input from the analyst corresponding to the determined discrepancy as part of the underwritten financial instrument data.

15. The system of claim J14, wherein the expert underwriting logic is further operative to:
receive input from the analyst that identifies a new determined discrepancy in data corresponding to the input financial instrument, and
store any received input from the analyst corresponding to the new determined discrepancy as part of the underwritten financial instrument data.

16. The system of claim 1, wherein the financial instrument data processing logic is further operative to receive client business rules from a particular client of the system for use in processing an input financial instrument, and
wherein the expert underwriting logic is further operative to apply said client business rules to the financial instrument data to determine the existence of a discrepancy between the normalized financial instrument data and the requirements of said client business rules.

17. The system of claim 1, wherein the forecast modeling logic comprises a statistical model of weight assignments associated with selected data fields in the normalized financial instrument data and the underwritten financial instrument data, said weight assignments derived from reference to said historical collection of financial instrument data.

18. The system of claim 17, wherein the statistical model determines weight assignments for public data fields in the normalized financial instrument data that indicate the likelihood that the financial instrument possesses fraud or misrepresentation.

19. The system of claim 18, wherein the public data fields are selected from the group comprising: mortgage loan amount, property type, unemployment rate, year of mortgage origination, occupation, wages.

20. The system of claim 17, wherein the statistical model determines weight assignments for public data fields and non-public data fields in the normalized financial instrument data that indicate the likelihood that the financial instrument possesses fraud or misrepresentation.

21. The system of claim 20, wherein the non-public data fields are selected from the group comprising: previous bankruptcies of a loan applicant, difference between property appraisal type and sales price, social security number match, loans of the applicant prior to the current loan application.

22. A computer-implemented method for determining and reporting risk associated with a financial instrument to a client, comprising the steps of:
receiving financial instrument data input to a computer system having a computer memory and a processor coupled to the computer memory, the financial instrument data comprising digitized image files and financial instrument origination data corresponding to an input financial instrument for which risk is to be determined and reported to a client;
normalizing the financial instrument data with the computer system;
storing normalized financial instrument data corresponding to the input financial instrument in the computer memory for use in other processing steps;
executing an expert underwriting process in the computer system, the expert underwriting process operative to (a) provide a user interface to a financial instrument analyst for inspection of the normalized financial instrument data stored in the computer memory, (b) access third party information sources to obtain supplemental data for use in connection with determining a risk of the financial instrument, (c) automatically determine the existence of a discrepancy between data in the normalized financial instrument data and any supplemental information obtained from a third party information source, (d) automatically assign a predetermined fraud type to any determined discrepancy, and (e) store information corresponding to the financial instrument data, any determined discrepancies, and any assigned predetermined fraud types in the computer memory as underwritten financial instrument data;
assigning a risk assessment score to the input financial instrument as represented by the normalized financial instrument data and the underwritten financial instrument data, the risk assessment scored calculated by the computer system based upon a historical collection of financial instrument data, the historical collection of financial instrument data comprising data corresponding to a plurality of prior financial instruments that (i) are of a type similar to that of the input financial instrument and (ii) have been predetermined to possess at least one of the predetermined fraud types;
storing the risk assessment score in the computer memory in association with data corresponding to the input financial instrument; and
outputting the risk assessment score corresponding to the input financial instrument stored in the computer memory to the client via a client user interface.

23. The method of claim 1, wherein the financial instrument is a mortgage loan.

24. The method of claim 1, wherein the financial instrument is a portfolio of mortgage loans.

25. The method of claim 1, wherein the financial instrument origination data comprises data related to the origination of the financial instrument that includes but is not limited to amount, date of transaction, location and type of collateral, and/or entity associated with the financial instrument.

26. The method of claim 1, wherein the step of receiving financial instrument data includes receiving entity data corresponding to the financial instrument comprising name, date of birth, address, social security number, previous mortgages, payment history, interest rate, and/or payments made on previous mortgages.

27. The method of claim 1, further comprising the step of processing the digitized image files to extract data with optical character recognition (OCR) and storing extracted data in the computer memory for use in connection with the normalizing step.

28. The method of claim 1, further comprising the step of receiving a set of client business rules for each one of a plurality of clients, each set of client business rules corresponding to specific policies of qualifying mortgage loan data for a particular client.

29. The method of claim 1, wherein the step of normalizing the financial instrument data comprises a mapping of data items in the received financial instrument data to corresponding data items in database that stores normalized financial instrument data for a plurality of similar financial instruments, the database comprising a part of the computer memory.

30. The method of claim 29, wherein the database of normalized financial instrument data comprises a mortgage fraud detection system (MFDS) database.

31. The method of claim 29, further comprising the step of utilizing a proprietary template containing information for mapping information between data items (column) in financial instrument data provided by a particular client of the system to corresponding data items in the database, the proprietary template of the particular client utilized in the normalization operation.

32. The method of claim 1, wherein the third party information sources are selected from the group comprising: credit bureau agencies, bankruptcy courts, government agencies, commercial information databases (e.g. Lexis/Nexis), mortgage electronic registration system (MERS).

33. The method of claim 1, wherein a discrepancy between data in the normalized financial instrument data and any supplemental information obtained from a third party information source comprises an indication of a difference between a data item contained in the information provided in the normalized financial instrument data and a corresponding data item obtained from a third party information source, where the information between the two data items is expected to be identical.

34. The method of claim 1, wherein the predetermined fraud types are selected from the group comprising: appraisal fraud, compliance fraud, liabilities fraud, misrepresentation fraud, occupancy fraud.

35. The method of claim 1, wherein the expert underwriting process is further operative to:
display information relating to any determined discrepancy and any automatically assigned predetermined fraud type to an analyst via the analyst user interface;
receive input from the analyst via the analyst user interface corresponding to the determined discrepancy; and
store any received input from the analyst corresponding to the determined discrepancy as part of the underwritten financial instrument data.

36. The method of claim 35, wherein the expert underwriting process is further operative to:
receive input from the analyst via the analyst user interface that identifies a new determined discrepancy in data corresponding to the input financial instrument, and
store any received input from the analyst corresponding to the new determined discrepancy as part of the underwritten financial instrument data.

37. The method of claim 1, further comprising the steps of:
receiving client business rules from a particular client for use in processing an input financial instrument, and
applying said client business rules to the financial instrument data to determine the existence of a discrepancy between the normalized financial instrument data and the requirements of said client business rules.

38. The method of claim 1, wherein the step of assigning a risk assessment score to the input financial instrument comprises utilizing a statistical model of weight assignments associated with selected data fields in the normalized financial instrument data and the underwritten financial instrument data, said weight assignments derived from reference to said historical collection of financial instrument data.

39. The method of claim 38, wherein the statistical model determines weight assignments for public data fields in the normalized financial instrument data that indicate the likelihood that the financial instrument possesses fraud or misrepresentation.

40. The method of claim 39, wherein the public data fields are selected from the group comprising: mortgage loan amount, property type, unemployment rate, year of mortgage origination, occupation, wages.

41. The method of claim 38, wherein the statistical model determines weight assignments for public data fields and non-public data fields in the normalized financial instrument data that indicate the likelihood that the financial instrument possesses fraud or misrepresentation.

42. The method of claim 41, wherein the non-public data fields are selected from the group comprising: previous bankruptcies of a loan applicant, difference between property appraisal type and sales price, social security number match, loans of the applicant prior to the current loan application.
